(19) United States
(12) Patent Application Publication
(10) Pub. No.: US 2016/0294143 A1
(43) Pub. Date: Oct. 6, 2016

(54) TERMINAL INSERTION DEVICE AND WIRING MODULE PRODUCTION METHOD

(71) Applicant: SUMITOMO WIRING SYSTEMS, LTD., Mie (JP)

(72) Inventor: Hideoki HORIKI, Mie (JP)

(73) Assignee: SUMITOMO WIRING SYSTEMS, LTD., Mie (JP)

(21) Appl. No.: 15/103,653

(22) PCT Filed: Dec. 10, 2014
(86) PCT No.: PCT/JP2014/082704

§ 371 Date: Jun. 10, 2016

(30) Foreign Application Priority Data
Dec. 26, 2013 (JP) 2013-269378

(51) Int. Cl. H01R 43/20

(52) U.S. Cl. CPC H01R 43/20

(57) ABSTRACT

It is an object of the present invention to enable a terminal to be inserted into a cavity of a connector more reliably. A terminal insertion device inserts a terminal at an end of a terminal-attached electric wire into a cavity of a connector. An insertion wire end holding unit (fourth clamping unit) is advanced toward the cavity in order to insert a front end portion of the terminal at the end of the terminal-attached electric wire held by the wire end holding unit into the cavity of the connector, and it is determined whether or not the front end portion of the terminal has entered the cavity. If it is determined that the front end portion of the terminal has not entered the cavity, the insertion wire end holding unit is retracted away from the cavity, and then the insertion wire end holding unit is again advanced toward the cavity.

### TECHNICAL FIELD

The present invention relates to a technique for inserting a terminal at an end of an electric wire into a connector.

### BACKGROUND ART

Patent Document 1 discloses a terminal insertion device that includes a housing holding unit, an insertion unit, and a control unit. The housing holding unit is configured to be capable of holding a connector housing so that it can move in horizontal and vertical directions. The insertion unit is configured to insert terminal fittings attached to electric wires into terminal accommodating chambers of the connector housing.

### CITATION LIST

### Patent Document

Patent Document 1: JP 2009-64722A

### SUMMARY OF INVENTION

### Technical Problem

However, in the technique disclosed in Patent Document 1, there may be a case where a terminal fitting is not held at a predetermined position and orientation with respect to the insertion unit. In this case, even if the insertion unit attempts to insert the terminal fitting into a predetermined terminal accommodating chamber of the connector housing, the position of the terminal fitting and the position of the terminal accommodating chamber will be shifted, and the terminal fitting will collide against the connector housing in the vicinity of the opening of the terminal accommodating chamber. Accordingly, insertion of the terminal fitting may be unsuccessful.

Therefore, it is an object of the present invention to enable a terminal to be inserted into a cavity of a connector more reliably.

### Solution to Problem

In order to solve the above-described problem, according to a first aspect, a terminal insertion device for inserting a terminal at an end of a terminal-attached electric wire into a cavity of a connector, includes: a connector supporting unit for holding the connector; an insertion wire end holding unit capable of holding the end of the terminal-attached electric wire; an insertion advancing and retracting driving unit for advancing and retracting the insertion wire end holding unit toward and away from the cavity; and a control unit for executing a step (a) of causing the insertion advancing and retracting driving unit to advance the insertion wire end holding unit toward the cavity in order to insert a front end portion of the terminal at the end of the terminal-attached electric wire held by the wire end holding unit into the cavity of the connector, a step (b) of determining whether or not the front end portion of the terminal has entered the cavity based on a detection signal that corresponds to a physical amount that is required when the insertion advancing and retracting driving unit advances the insertion wire end holding unit in the step (a), and a step (c) of, if it is determined in the step (b) that the front end portion of the terminal has not entered the cavity, retracting the insertion wire end holding unit away from the cavity and then again advancing the insertion wire end holding unit toward the cavity.

According to a second aspect, the terminal insertion device according to the first aspect further includes: a relative position changing mechanism for changing a relative positional relationship between the connector supporting unit and the insertion wire end holding unit in a direction orthogonal to the axis of the cavity, and in the step (c), the control unit lets the relative position changing mechanism change a relative positional relationship between the connector supporting unit and the insertion wire end holding unit in a direction orthogonal to the axis of the cavity, and then advance the insertion wire end holding unit toward the cavity.

According to a third aspect, the terminal insertion device according to the first or second aspect is such that the insertion wire end holding unit is configured to be capable of clamping the end of the terminal-attached electric wire, and in the step (c), the control unit lets the relative position changing mechanism change the relative positional relationship between the connector supporting unit and the insertion wire end holding unit in a direction that is orthogonal to the axis of the cavity, and that is orthogonal to the direction in which the insertion wire end holding unit clamps the end of the terminal-attached electric wire.

According to a fourth aspect, the terminal insertion device according to any one of the first to third aspects is such that the insertion advancing and retracting driving unit includes a motor for generating a thrust force for advancing and retracting the insertion wire end holding unit toward and away from the cavity, and the control unit determines whether or not the front end portion of the terminal has entered the cavity based on a torque of the motor.

According to a fifth aspect, a wiring module production method in which a terminal at an end of a terminal-attached electric wire is inserted into a cavity of a connector is such that a terminal insertion device is used to produce a wiring module in which the terminal at the end of the terminal-attached electric wire is inserted into the cavity of the connector, the terminal insertion device including: a connector supporting unit for holding the connector; an insertion wire end holding unit capable of holding the end of the terminal-attached electric wire; and an insertion advancing and retracting driving unit for advancing and retracting the insertion wire end holding unit toward and away from the cavity, the wiring module production method including a step (a) of advancing the insertion wire end holding unit toward the cavity in order to insert a front end portion of the terminal at the end of the terminal-attached electric wire held by the wire end holding unit into the cavity of the connector, a step (b) of determining whether or not the front end portion of the terminal has entered the cavity based on a detection signal that corresponds to a physical amount required when the insertion advancing and retracting driving unit advances the insertion wire end holding unit in the step (a), and a step (c) of, if it is determined in the step (b) that the front end portion of the terminal has not entered the cavity, retracting the insertion wire end holding unit away from the cavity and then again advancing the insertion wire end holding unit toward the cavity.

### Advantageous Effects of the Invention

According to the first to fifth aspects, if it is determined that the front end portion of the terminal has not entered the cavity, the insertion wire end holding unit is retracted away from the cavity, and then the insertion wire end holding unit is again advanced toward the cavity, thus enabling the front end portion of the terminal to enter the cavity of the connector more reliably. Also, by further inserting the terminal after the front end portion of the terminal has entered the cavity of the connector, it is possible to insert the terminal into the cavity more reliably.

According to the second aspect, the relative positional relationship between the connector supporting unit and the insertion wire end holding unit is changed in a direction orthogonal to the axis of the cavity, and then the insertion wire end holding unit is advanced toward the cavity, thus enabling the front end portion of the terminal to enter the cavity of the connector more reliably.

If the insertion wire end holding unit is configured to clamp and hold an end of a terminal-attached electric wire, it is considered that misalignment of the terminal with respect to the cavity is likely to occur in a direction orthogonal to the direction in which it clamps the end. Accordingly, by the control unit letting, in the step (c), the relative position changing mechanism change the relative positional relationship between the connector supporting unit and the insertion wire end holding unit in a direction that is orthogonal to the axis of the cavity, and to the direction in which the insertion wire end holding unit clamps the end of the terminal-attached electric wire, it is possible for the front end portion of the terminal to enter the cavity of the connector more reliably.

According to the fourth aspect, with a simple configuration, by using a torque of a motor, it is possible to determine whether or not the front end portion of the terminal has entered the cavity based on the torque of the motor.

### BRIEF DESCRIPTION OF DRAWINGS

FIG. 1 is a perspective view schematically illustrating a terminal, insertion device according to an embodiment.

FIG. 2 is a plan view schematically illustrating the terminal insertion device.

FIG. 3 is a plan view schematically illustrating the terminal insertion device that performs an operation position shift process.

FIG. 4 is a plan view schematically illustrating the terminal insertion device that performs a clamping start process.

FIG. 5 is a plan view schematically illustrating the terminal insertion device that performs a first transport primary process.

FIG. 6 is a plan view schematically illustrating the terminal insertion device that performs a first transport secondary process.

FIG. 7 is a plan view schematically illustrating the terminal insertion device that performs a first transfer process.

FIG. 8 is a plan view schematically illustrating the terminal insertion device that performs a second transport process.

FIG. 9 is a plan view schematically illustrating the terminal insertion device that performs a second transfer process.

FIG. 10 is a plan view schematically illustrating the terminal insertion device that performs a third transport process.

FIG. 11 is a plan view schematically illustrating the terminal insertion device that performs a third transfer process.

FIG. 12 is a plan view schematically illustrating the terminal insertion device that performs a fourth transport primary process.

FIG. 13 is a plan view schematically illustrating the terminal insertion device that performs a fourth transport secondary process.

FIG. 14 is a plan view illustrating ends of terminal-attached electric wires that are attached to a wire arraying member.

FIG. 15 is a diagram schematically illustrating a wiring module.

FIG. 16 is a perspective view schematically illustrating an example of an operation of inserting a terminal into a cavity.

FIG. 17 is a functional block diagram illustrating a part of the terminal insertion device.

FIG. 18 is a flowchart illustrating an operation of the terminal insertion device.

FIG. 19 is a diagram illustrating an example of the operation of inserting a terminal into a cavity.

FIG. 20 is a diagram illustrating an example of the operation of inserting a terminal into a cavity.

FIG. 21 is a diagram illustrating an example of the operation of inserting a terminal into a cavity.

FIG. 22 is a diagram illustrating an example of the operation of inserting a terminal into a cavity.

FIG. 23 is a diagram illustrating an example of the operation of inserting a terminal into a cavity.

FIG. 24 is a diagram illustrating an example of the operation of inserting a terminal into a cavity.

FIG. 25 is a diagram illustrating an example of the operation of inserting a terminal into a cavity.

FIG. 26 is a diagram illustrating an example of the operation of inserting a terminal into a cavity.

FIG. 27 is a diagram illustrating an example of the operation of inserting a terminal into a cavity.

FIG. 28 is a diagram illustrating an example of the operation of inserting a terminal into a cavity.

### DESCRIPTION OF EMBODIMENT

Hereinafter, an embodiment will be described with reference to the accompanying drawings. The embodiment below is an example in which the present invention is embodied, and does not restrict the technical scope of the present invention.

### Wiring Module Manufacturing Device

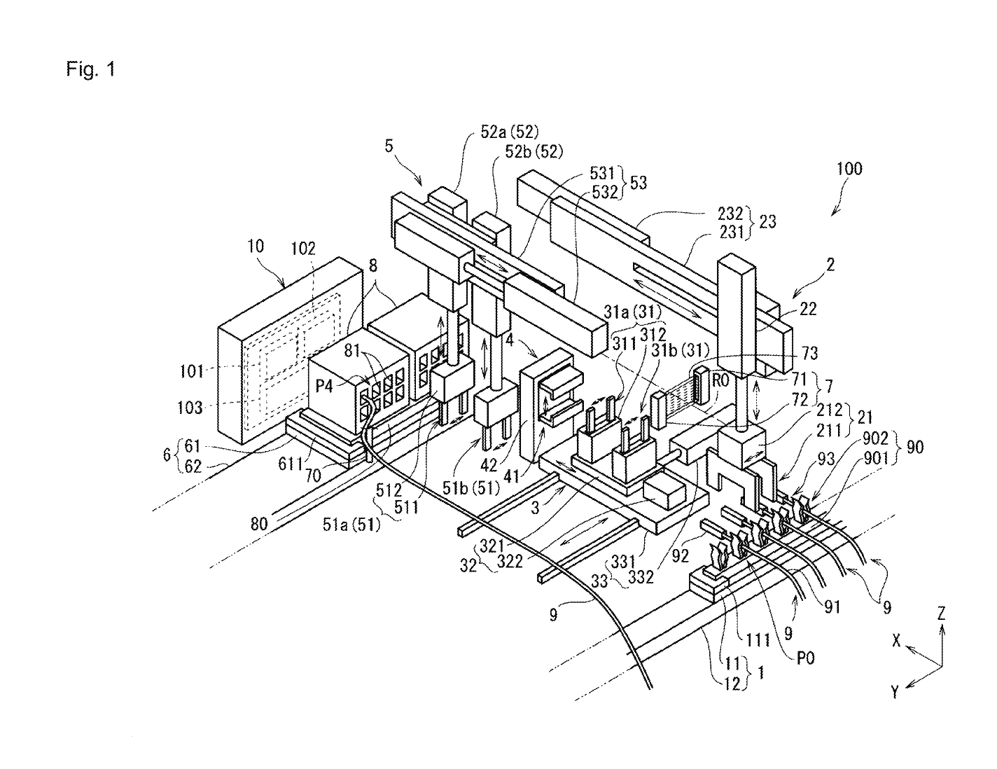

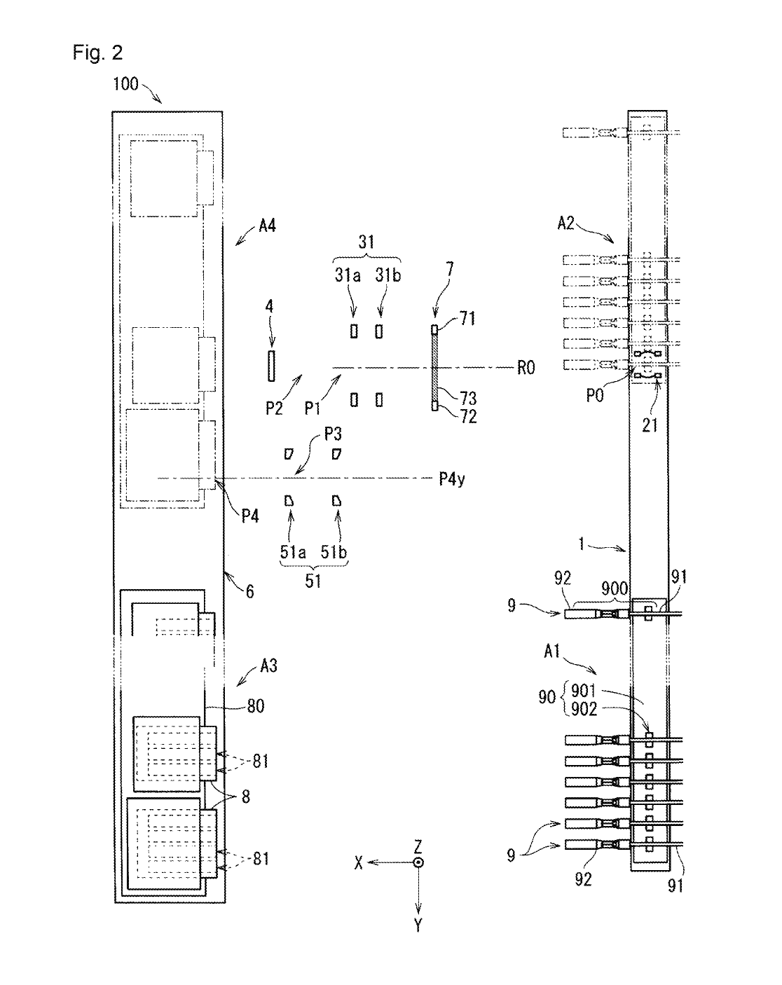

The overall configuration of a terminal insertion device 100 according to an embodiment will first be described with reference to FIGS. 1 and 2. The terminal insertion device 100 is a device for producing a wiring module 200 (see FIG. 15) that includes at least one terminal-attached electric wire 9 and at least one connector 8, by inserting a terminal 92 at an end of the terminal-attached electric wire 9 (i.e. an electric wire 9 to which a terminal is attached) into a cavity 81 of the connector 8. Particularly, the terminal insertion device 100 of the present embodiment is a device for producing a wiring module. 200 that includes a plurality of terminal-attached electric wires 9 and a plurality of connectors 8. Note that the wiring module 200 may be configured as a wire harness for electrical wiring in a vehicle or the like by being bundled alone in a shape conforming to a wiring path of the vehicle. Alternatively, the wiring module 200 may be configured as a wire harness for electrical wiring in a vehicle or the like by being bundled in combination with another wiring module and at least one of its electric wires in a shape conforming to a wiring path of the vehicle.

Note that, for convenience, illustrations of the constituent components do not necessarily match each other between FIGS. 1 and 2 in details such as the shape and the size. Furthermore, in FIG. 2, illustrations of some mechanisms shown in FIG. 1 are omitted.

The terminal insertion device 100 is provided with a wire arraying member transport mechanism 1, terminal insertion mechanisms 2 to 5, a connector arraying member transport mechanism 6, a light sensor 7, and a control unit 10. The terminal insertion mechanisms 2 to 5 include a first clamping unit-associated mechanism 2, a second clamping unit-associated mechanism 3, a third clamping unit 4, and a fourth clamping unit-associated mechanism 5.

Hereinafter, the overall configuration of the terminal insertion device 100 will be described, and then a description will be given with focus on a configuration in which a terminal 92 is inserted into the cavity 81 of the connector 8.

### Terminal-Attached Electric Wire

Each terminal-attached electric wire 9 includes an electric wire 91 and terminals 92 connected to the ends of the electric wire 91. The electric wire 91 is an insulated electric wire that includes a linear conductor and an insulating coating covering the circumference of this conductor. The terminal 92 is an electrically-conductive member made of metal or the like. The terminal 92 of the present embodiment is a crimp-type terminal, and has a conductor-crimped part, which is crimped to the conductor of the electric wire 91, and a coating-crimped part, which is crimped to the insulating coating portion of the electric wire 91.

### Connector

Each connector 8 is a member having a plurality of cavities 81 for accommodating the terminals 92 of the terminal-attached electric wires 9. The main portion of the connector 8 that forms its outer shape is a non-conductive member that is made of, for example, a synthetic resin such as polypropylene (PP), polyethylene (PE), polyvinyl chloride (PVC), polyethylene terephthalate (PET), or polyamide (PA). Furthermore, the connector 8 may include, in its main portion, not-shown busbars that get into contact with the terminals 92 of the terminal-attached electric wires 9 that are inserted into the cavities 81.

The connector 8 is provided with the cavities 81 into which the terminals 92 can be inserted and that are arrayed in a predetermined configuration. Each cavity 81 is provided with a lance or the like serving as an engagement structure for retaining and engaging with a terminal 92, and when the terminal 92 is inserted into the cavity 81, the lance or the like retains and engages with the terminal 92, whereby the terminal 92 is held in the cavity 81.

### Wire Arraying Member Transport Mechanism

The wire arraying member transport mechanism 1 is a mechanism for moving a wire arraying member 90 while holding it so that it can be removed. The wire arraying member 90 has an elongated base portion 901 and a plurality of wire retaining portions 902 protruding from the base portion 901. Each wire retaining portion 902 includes a pair of members that clamp and retain, with their elastic force, a portion of the electric wire 91 of the terminal-attached electric wire 9 that is close to the terminal 92.

The plurality of wire retaining portions 902 are formed on the base portion 901 so as to be line up in a line. Furthermore, the wire retaining portions 902 of the wire arraying member 90 respectively clamp and retain the electric wires 91 of the terminal-attached electric wires 9 in a state in which the front ends of the terminals 92 of the terminal-attached electric wires 9 point in the same direction. The direction in which the wire retaining portions 902 are lined up is a direction that is orthogonal to the direction in which the front ends of the terminals 92 of the terminal-attached electric wires 9 point.

For example, the pairs of members of the wire retaining portions 902 are themselves elastically deformable members, and clamp and retain the electric wires 91 with the elastic force generated by the elastic deformation. Alternatively, the pairs of members of the wire retaining portions 902 may be subjected to an elastic force in a direction in which the members of each pair approach each other by not-shown elastic bodies such as springs.

Ordinarily, the terminals 92 are connected to both ends of the terminal-attached electric wires 9 retained by the wire arraying member 90. Also, the wire arraying member 90 supports the portions of the electric wires 91 at both ends of the plurality of terminal-attached electric wires 9 using the wire retaining portions 902. Accordingly, the wire arraying member 90 clamps the electric wires 91 at twice as many positions as there are terminal-attached electric wires 9, using the wire retaining portions 902.

The wire arraying member transport mechanism 1 is provided with a fixing seat 11 and a linear actuator 12. The fixing seat 11 is a portion for holding the wire arraying member 90 so that it can be removed. The fixing seat 11 is provided with a wire arraying member locking mechanism 111 that has a structure of capable of holding the wire arraying member 90 and releasing the holding. For example, a well-known locking mechanism capable of holding a counterpart member with an engagement structure and releasing the holding may be employed as the wire arraying member locking mechanism 111.

Note that in FIG. 2, an illustration of the wire arraying member locking mechanism 111 is omitted.

In the description below, the direction in which the front ends of the terminals 92 of the terminal-attached electric wires 9 supported by the wire arraying member 90 point while the wire arraying member 90 is held on the fixing seat 11 is referred to as “first direction”. In the present embodiment, the first direction is the horizontal direction.

Furthermore, a direction that is along the direction in which the wire retaining portions 902 are lined up while the wire arraying member 90 is held on the fixing seat 11 is referred to as “second direction”. The second direction is orthogonal to the first direction. In the present embodiment, the second direction is also the horizontal direction. In the coordinate axes of the drawings, the positive X-axis direction is the first direction, and the positive Y-axis direction is the second direction.

Accordingly, the fixing seat 11 holds the wire arraying member 90 in a state in which the front ends of the terminals 92 of the terminal-attached electric wires 9 supported by the wire arraying member 90 point in the first direction, and the direction in which the wire retaining portions 902 are lined up is along the second direction, which is orthogonal to the first direction.

The linear actuator 12 moves the fixing seat 11 in the second direction, that is, in the Y-axis direction. By moving the fixing seat 11 in the second direction, the linear actuator 12 selectively positions the wire retaining portions 902 of the wire arraying member 90 at a predetermined start position P0. The linear actuator 12 is, for example, a well-known ball screw-type electric actuator or the like.

In the state in which the wire arraying member 90 is held on the fixing seat 11, the positions of the respective wire retaining portions 902, that is, the positions of the respective electric wires 91 retained by the wire retaining portions 902 are known. For example, it is conceivable that the plurality of wire retaining portions 902 are lined up in a line at equal intervals from the reference position of the fixing seat 11. In this case, if an ordinal number indicating the position of a target wire retaining portion 902 from an end is designated, then the amount by which the linear actuator 12 needs to be operated to move the target wire retaining portion 902 and the electric wire 91 retained by the target wire retaining portion 902 to the start position P0 (the direction and distance in which the fixing seat 11 is to be transported) will be defined.

As shown in FIG. 2, the wire arraying member transport mechanism 1 can move the wire arraying member 90 in the first direction in a range from a first waiting position A1, at which the entire wire arraying member 90 is away from the start position P0, to a first operation position A2, at which a part of the wire arraying member 90 is located at the start position P0.

The wire arraying member 90 supporting the ends of the plurality of terminal-attached electric wire 9, that is, a module of the wire arraying member 90 is prepared for, for example, each wiring module 200.

In a process that is performed prior to the process that is performed by the terminal insertion device 100, the respective ends of the terminal-attached electric wires 9 are fixed to the wire retaining portions 902 of the wire arraying member 90 using a manual operation or another device. Then, the module of the wire arraying member 90 is delivered from a position at which the other process was performed to the place of the terminal insertion device 100, and is mounted on the wire arraying member transport mechanism 1.

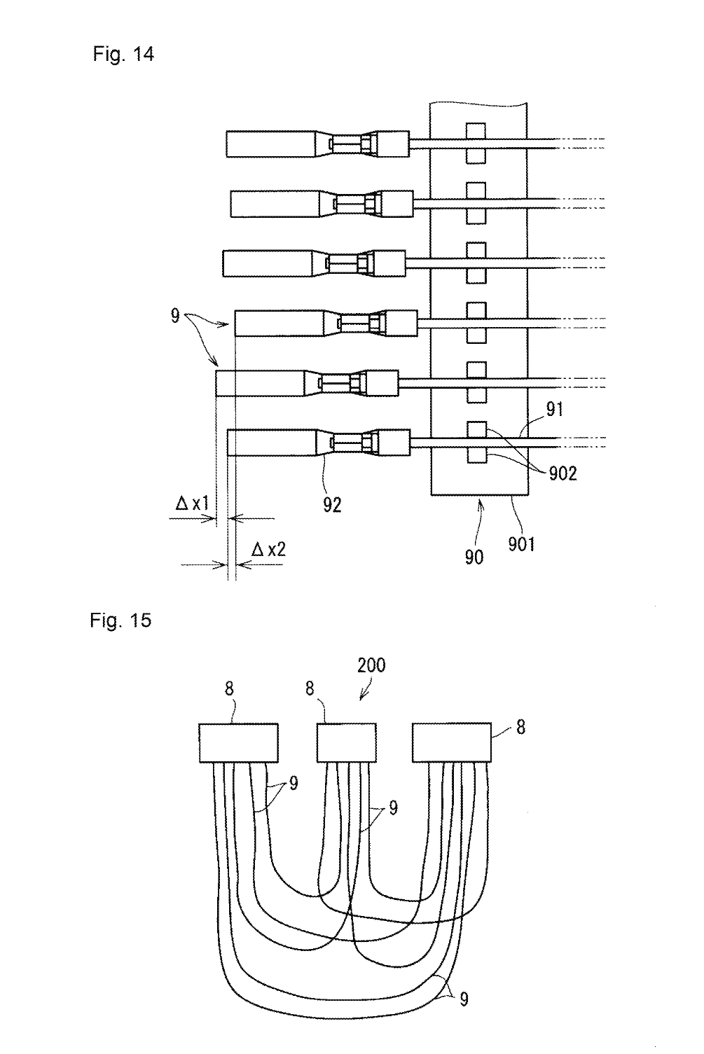

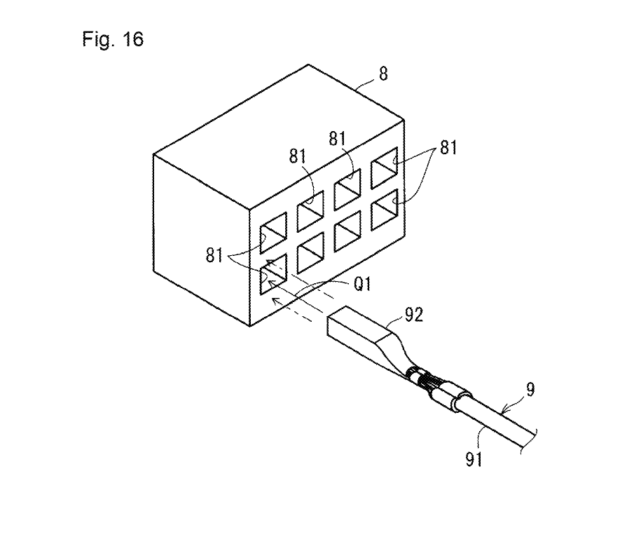

FIG. 14 is a plan view illustrating the ends of the terminal-attached electric wires 9 that are retained by the wire arraying member 90. As shown in FIG. 14, in the module of the wire arraying member 90, the positions at which the wire retaining portions 902 respectively clamp the electric wires 91 of the terminal-attached electric wires 9 may vary. Δx1 and Δx2 of FIG. 14 denote variations in the lengths of the portions of the ends of the terminal-attached electric wires 9 that are protruding from the wire retaining portion 902.

A variation in the positions at which the wire retaining portions 902 respectively clamp the electric wires 91 of the terminal-attached electric wires 9 is caused by, for example, a variation in the process in which the ends of the terminal-attached electric wire 9 are fixed to the wire retaining portions 902, or by a misalignment due to external forces applied to the terminal-attached electric wires 9 during the delivery of the wire arraying member 90.

The variation in the positions at which the wire retaining portions 902 respectively clamp the electric wires 91 becomes a variation in the position of the end of the terminal-attached electric wire 9 that is positioned at the start position P0 by the wire arraying member transport mechanism 1. Furthermore, a variation in the positions of the electric wires 91 in the depth direction of the wire retaining portions 902 is also conceivable. Furthermore, there may be cases where, depending on a variation in accuracy of connection of the terminal 92 to the end of the electric wire 91, the terminal 92 may slightly be inclined with respect to the longitudinal direction of the electric wire 91. Also such a variation in the inclination may cause a variation in the positions of the terminals 92.

As will be described later, the terminal insertion device 100 has a function of correcting such a variation in the position of the end of the terminal-attached electric wire 9 before the terminal 92 of the terminal-attached electric wire 9 reaches the cavity 81 of the connector 8.

In the description below, a region of each terminal-attached electric wire 9 from the terminal 92 to a portion of the electric wire 91 that is close to the terminal 92 is referred to as an “end region 900”.

### Connector Arraying Member Transport Mechanism

The connector arraying member transport mechanism 6 is a mechanism for moving a connector arraying member 80 while holding it so that it can be removed. The connector arraying member 80 has a not-shown holding mechanism for holding the plurality of connectors 8 in a state in which each connector 8 can be removed.

The connector arraying member 80 supports the plurality of connectors 8 in a state in which they are lined up in at least one line. In the examples shown in FIGS. 1 and 2, the connector arraying member 80 supports the plurality of connectors 8 in the state in which they are lined up in one line. However, it is conceivable that the connector arraying member 80 supports the plurality of connectors 8 that are stacked on one another in two or more stages and are lined up in one line on each stage.

The connector arraying member 80 supports the plurality of connectors 8 in a state in which the entrances of the cavities 81 thereof face in the same direction. More specifically, the connector arraying member 80 supports the plurality of connectors 8 in the state in which the entrances of the cavities 81 of the plurality of connectors 8 face in the same direction and the direction in which the connectors 8 are lined up is orthogonal to the direction in which the entrances of the cavities 81 face.

The connector arraying member transport mechanism 6 is provided with a fixing seat 61 and a linear actuator 62. The fixing seat 61 is a portion for holding the connector arraying member 80 so that it can be removed. The fixing seat 61 is provided with a connector arraying member locking mechanism 611 that has a structure that is capable of holding the connector arraying member 80 and releasing the holding. For example, a locking mechanism similar to the wire arraying member locking mechanism 111 is employed as the connector arraying member locking mechanism 611.

The fixing seat 61 holds the connector arraying member 80 so that is can be removed, in a state in which the plurality of connectors 8 supported by the connector arraying member 80 are lined up in a direction parallel to the direction in which the wire retaining portions 902 are lined up. In this case, the fixing seat 61 holds the connector arraying member 80 in a state in which the plurality of connectors 8 are lined up in the second direction, and the entrances of the cavities 81 of the plurality of connectors 8 face in a direction opposite to the first direction (the negative X-axis direction).

This fixing seat 61 serves as a connector supporting unit for holding the connectors 8 when the terminals 92 are inserted into the cavities 81 of the connectors 8.

Note that in the example shown in FIG. 2, although the fixing seat 61 of the connector arraying member 80 has a structure in which the connectors 8 are fitted therein, an illustration of this structure is omitted in FIG. 2. Furthermore, in FIG. 2, an illustration of the connector arraying member locking mechanism 611 is also omitted.

The linear actuator 62 moves the fixing seat 61 in the second direction, that is, the Y-axis direction. By moving the fixing seat 61 in the second direction, the linear actuator 62 selectively positions a cavity 81 of the connector 8 supported by the connector arraying member 80 at a predetermined end position P4. The linear actuator 62 is, for example, a well-known ball screw-type electric actuator or the like.

The end position P4 is a position in the second direction. The end position P4 is a position that is aligned, in the second direction, with a third intermediate position P3, which will be described later. In other words, the coordinate P4y in the second direction representing the end position P4 corresponds to the coordinate of the third intermediate position P3 in the second direction.

In the state in which the connector arraying member 80 is held on the fixing seat 61, the positions of the cavities 81 of the connectors 8 are known. The positions of the cavities 81 on the connector arraying member 80 are determined by the position of each connector 8 on the fixing seat 61, and the specification of the shape of the connector 8.

For example, in the control unit 10, identification codes of the cavities 81 of the connectors 8 and data on the positions on the fixing seat 61 that correspond to the respective identification codes are set in advance. In this case, if the identification code of a target cavity 81 is designated, the amount of operation (transport direction and distance for the fixing seat 61) of the linear actuator 62 for moving the target cavity 81 to the end position P4 will be determined with reference to the data on the position of the cavity 81 in the second direction that corresponds to the identification code.

Note that the target cavity 81 is the place into which the terminal 92 is to be inserted, and is sequentially selected from the plurality of cavities 81 of the plurality of connectors 8 supported by the connector arraying member 80. If, at the end position P4, a plurality of cavities 81 are lined up in a third direction, one of the plurality of cavities 81 lined up in the third direction will serve as the target cavity 81.

As shown in FIG. 2, the connector arraying member transport mechanism 6 can move the connector arraying member 80 in the first direction in a range from a second waiting position A3, at which the entire connector arraying member 80 is away from the end position P4, to a second operation position A4, at which a part of the connector arraying member 80 is located at the end position P4.

As shown in FIG. 2, the direction in which the first waiting position A1 is located with respect to the first operation position A2 is the same as the direction in which the second waiting position A3 is located with respect to the second operation position A4. In the present embodiment, the second waiting position A3 is located in the first direction (positive X-axis direction) with respect to the first waiting position A1.

The connector arraying member 80 for supporting the plurality of connectors 8, that is, a module of the connector arraying member 80 is prepared for, for example, each wiring module 200.

In a process that is performed prior to the process that is performed by the terminal insertion device 100, the plurality of connectors 8 are attached to the connector arraying member 80 that is produced in advance according to the specifications of the shapes of the connectors 8. Then, the module of the connector arraying member 80 is delivered from the place at which the other process was performed to the place of the terminal insertion device 100, and is mounted on the connector arraying member transport mechanism 6.

### Light Sensor

The light sensor 7 is a transmission type optical sensor, and includes a light emitting unit 71 and a light receiving unit 72. The light emitting unit 71 outputs detection light 73 along a plane that is orthogonal to a straight path R0 passing through the start position P0 when viewed in the third direction, which is orthogonal to the first and second directions. The detection light 73 is sheet light extending along a plane.

Note that in the coordinate axes of the drawings, the positive Z-axis direction is the third direction. In the present embodiment, the third direction is the vertically upward direction.

The light receiving unit 72 of the light sensor 7 receives the detection light 73. The light sensor 7 is a sensor for detecting an object blocking the detection light 73 by detecting whether or not the light receiving level of the light receiving unit 72 is lower than a preset level. In the terminal insertion device 100, the light sensor 7 detects the front end portion of the terminal 92 of the terminal-attached electric wire 9 that blocks the detection light 73.

### Terminal Insertion Mechanisms

The terminal insertion mechanisms 2 to 5 are mechanisms for inserting a terminal 92 of a terminal-attached electric wire 9 into a target cavity 81 located at the end position P4. The terminal insertion mechanisms 2 to 5 move, while clamping, a part of the end region 900 of the terminal-attached electric wire 9 so as to thereby remove the end region 900 of the terminal-attached electric wire 9 from the wire retaining portion 902 at the start position P0, and insert the terminal 92 of the moved end region 900 of the terminal-attached electric wire 9 into the target cavity 81 located at the end position P4.

Note that in FIG. 2, for convenience, only portions of the terminal insertion mechanisms 2 to 5 that are configured to clamp a part of the end region 900 of the terminal-attached electric wire 9 are schematically illustrated, and illustrations of other portions of the mechanisms are omitted.

### First Clamping Unit-Associated Mechanism

Of the terminal insertion mechanisms 2 to 5, the first clamping unit-associated mechanism 2 is a mechanism for moving the end region 900 from the start position P0 to a predetermined first intermediate position P1 while clamping a part of the end region 900 of the terminal-attached electric wire 9.

The first clamping unit-associated mechanism 2 includes a first clamping unit 21, a third direction transport mechanism 22, and a first direction transport mechanism 23.

The first clamping unit 21 is a mechanism for clamping, at the start position P0, a part of the end region 900 of the terminal-attached electric wire 9 in which the front end of the terminal 92 is directed in the first direction from both sides in the second direction.

The first clamping unit 21 has a pair of first opposing members 211, and a first separating and approximating actuator 212 for bringing the pair of first opposing members 211 close to each other and away from each other in the second direction (Y-axis direction).

Each of the pair of first opposing members 211 has two branched portions branched from the base portion. The branched portions of the pair of first opposing members 211 clamp and support the electric wire 91 of the terminal-attached electric wire 9 at its two positions respectively located on both sides of the portion clamped by the wire retaining portion 902.

The first separating and approximating actuator 212 brings the pair of first opposing members 211 close to each other or away from each other in the second direction. Accordingly, the first separating and approximating actuator 212 switches the state of the pair of first opposing members 211 to the state in which the electric wire 91 is clamped or to the state in which the clamping of the electric wire 91 is released. The first separating and approximating actuator 212 is, for example, a solenoid actuator, a ball screw-type electric actuator, or the like.

The third direction transport mechanism 22 of the first clamping unit-associated mechanism 2 is a mechanism for moving the first clamping unit 21 in the third direction. Furthermore, the first direction transport mechanism 23 of the first clamping unit-associated mechanism 2 is a mechanism for moving the first clamping unit 21 in the first direction.

The third direction transport mechanism 22 and the first direction transport mechanism 23 move the first clamping unit 21 along a plane that passes through the start position P0 and extends in the first and third directions. Therefore, the first intermediate position P1 is located in the plane that passes through the start position P0 and extends in the first and third directions.

In the present embodiment, the third direction transport mechanism 22 moves the first clamping unit 21 in the third direction while directly supporting it, and the first direction transport mechanism 23 moves the third direction transport mechanism 22 in the first direction while supporting it.

For example, the first direction transport mechanism 23 is provided with a slide supporting portion 231, which supports the third direction transport mechanism 22 so that it can move in the first direction, and a linear actuator 232 for moving the third direction transport mechanism 22 in the third direction. The third direction transport mechanism 22 and the linear actuator 232 are, for example, well-known ball screw-type electric actuators or the like.

While the third direction transport mechanism 22 and the first direction transport mechanism 23 move the end region 900 of the terminal-attached electric wire 9 from the start position P0 to the first intermediate position P1, the first direction transport mechanism 23 moves the end region 900 of the terminal-attached electric wire 9 along the straight path R0. The operations of the third direction transport mechanism 22 and the first direction transport mechanism 23 will be described later in further detail.

Note that the third direction transport mechanism 22 and the first direction transport mechanism 23 of the first clamping unit-associated mechanism 2 serve as examples of a first clamping unit transport mechanism for moving the end region 900 of the terminal-attached electric wire 9 to the first intermediate position P1 by moving the first clamping unit 21.

### Second Clamping Unit-Associated Mechanism

Of the terminal insertion mechanisms 2 to 5, the second clamping unit-associated mechanism 3 is a mechanism for taking over the support of the end region 900 of the terminal-attached electric wire 9 at the first intermediate position P1 from the first clamping unit 21. Furthermore, the second clamping unit-associated mechanism 3 temporarily transfers the support of the terminal 92 of the terminal-attached electric wire 9 to the third clamping unit 4, and then hands over the terminal-attached electric wire 9 to the fourth clamping unit-associated mechanism 5.

The second clamping unit-associated mechanism 3 includes a second clamping unit 31, a first direction transport mechanism 32, and a second direction transport mechanism 33.

The second clamping unit 31 clamps, at the first intermediate position P1, a part of the terminal 92 and a part of the electric wire 91 in the end region 900 of the terminal-attached electric wire 9 clamped by the first clamping unit 21 from both sides in the second direction (Y-axis direction). The second clamping unit 31 then takes over the support of the end region 900 of the terminal-attached electric wire 9 from the first clamping unit 21 at the first intermediate position P1.

The second clamping unit 31 includes a front second clamping unit 31a and a rear second clamping unit 31b. Each of the front second clamping unit 31a and the rear second clamping unit 31b includes a pair of second opposing members 311, and a second separating and approximating actuator 312 for bringing the pair of second opposing members 311 close to each other and away from each other in the second direction (Y-axis direction).

The pair of second opposing members 311 of the front second clamping unit 31a clamp and support a part of the terminal 92 in the end region 900 of the terminal-attached electric wire 9. On the other hand, the pair of second opposing members 311 of the rear second clamping unit 31b clamp and support a part of the electric wire 91 in the end region 900 of the terminal-attached electric wire 9.

Since the second clamping unit 31 includes the front second clamping unit 31a and the rear second clamping unit 31b, it is possible to perform the operations of clamping and unclamping the terminal 92 of the terminal-attached electric wire 9, and the operations of clamping and unclamping the electric wire 91 of the terminal-attached electric wire 9, independently.

The second separating and approximating actuators 312 bring the pairs of second opposing members 311 close to each other or away from each other in the second direction. Accordingly, each second separating and approximating actuator 312 switches the state of the pair of second opposing members 311 to the state in which the end region 900 of the terminal-attached electric wire 9 is clamped, or to the state in which the clamping of the end region 900 is released. The second separating and approximating actuators 312 are, for example, solenoid actuators, ball screw-type electric actuators, or the like.

The first direction transport mechanism 32 of the second clamping unit-associated mechanism 3 is a mechanism for moving the second clamping unit 31 in the first direction. Furthermore, the second direction transport mechanism 33 of the second clamping unit-associated mechanism 3 is a mechanism for moving the second clamping unit 31 in the second direction.

The first direction transport mechanism 32 moves the second clamping unit 31 from the first intermediate position P1 to a predetermined second intermediate position P2. Furthermore, the second direction transport mechanism 33 moves the second clamping unit 31 from the second intermediate position P2 to the predetermined third intermediate position P3. Furthermore, the first direction transport mechanism 32 and the second direction transport mechanism 33 move the second clamping unit 31 from the third intermediate position P3 to the first intermediate position P1.

In the present embodiment, the first direction transport mechanism 32 is provided with a slide supporting portion 321, which supports the second clamping unit 31 so that it can move in the first direction, and a linear actuator 322 for moving the slide supporting portion 321 in the first direction.

Furthermore, in the present embodiment, the second direction transport mechanism 33 is provided with a slide supporting portion 331, which supports the second clamping unit 31 and the first direction transport mechanism 32 so that they can move in the second direction, and a linear actuator 332 for moving the slide supporting portion 331 in the second direction.

### Third Clamping Unit

Of the terminal insertion mechanisms 2 to 5, the third clamping unit 4 clamps, at the predetermined second intermediate position P2, a part of the terminal 92 in the end region 900 of the terminal-attached electric wire 9 clamped by the second clamping unit 31 from both sides in the third direction. This third clamping unit 4 temporarily takes over the support of the terminal 92 of the terminal-attached electric wire 9 from the second clamping unit 31, and then hands over the support to the second clamping unit 31.

The third clamping unit 4 has a pair of third opposing members 41, and a third separating and approximating actuator 42 for bringing the pair of third opposing members 41 close to each other and away from each other in the third direction (Z-axis direction). In the present embodiment, the third clamping unit 4 is fixed.

The pair of third opposing members 41 clamp and support a part of the terminal 92 in the end region 900 of the terminal-attached electric wire 9.

The third separating and approximating actuator 42 brings the pair of third opposing members 41 close to each other or away from each other in the third direction. Accordingly, the third separating and approximating actuator 42 switches the state of the pair of third opposing members 41 to the state in which the terminal 92 of the terminal-attached electric wire 9 are clamped, or the state in which the clamping of the terminal 92 is released. The third separating and approximating actuator 42 is, for example, a solenoid actuator, a ball screw-type electric actuator, or the like.

Note that the first direction transport mechanism 32 of the second clamping unit-associated mechanism 3 is an example of a mechanism for changing a positional relationship between the second and third clamping units, the mechanism moving at least one of the second clamping unit 31 and the third clamping unit 4 in the first direction.

In other words, the first direction transport mechanism 32 changes the positional relationship of the terminal 92 of the terminal-attached electric wire 9 clamped by the second clamping unit 31 to the third clamping unit 4 between a first positional relationship and a second positional relationship. The first positional relationship is a positional relationship in which the third clamping unit 4 is separated from the terminal 92 in the first direction. The second positional relationship is a positional relationship in which the terminal 92 is located at a clamping position of the third clamping unit 4.

In the present embodiment, when the end region 900 of the terminal-attached electric wire 9 is located at the first intermediate position P1, the positional relationship between the terminal 92 and the third clamping unit 4 is the first positional relationship. Furthermore, when the end region 900 of the terminal-attached electric wire 9 is located at the second intermediate position P2, the positional relationship between the terminal 92 and the third clamping unit 4 is the second positional relationship.

### Fourth Clamping Unit-Associated Mechanism

Of the terminal insertion mechanisms 2 to 5, the fourth clamping unit-associated mechanism 5 is a mechanism for taking over the support of the end region 900 of the terminal-attached electric wire 9 from the second clamping unit 31 at the predetermined third intermediate position P3. Furthermore, the fourth clamping unit-associated mechanism 5 moves, while clamping, the end region 900 of the terminal-attached electric wire 9 so as to thereby insert the terminal 92 of the terminal-attached electric wire 9 into the cavity 81 of the connector 8 located at the end position P4.

The fourth clamping unit-associated mechanism 5 includes a fourth clamping unit 51, a third direction transport mechanism 52, and a first direction transport mechanism 53.

The fourth clamping unit 51 clamps, at the third intermediate position P3, a part of the terminal 92 and a part of the electric wire 91 in the end region 900 of the terminal-attached electric wire 9 that is clamped by the second clamping unit 31 after the second clamping unit 31 took over the support thereof from the third clamping unit 4. The fourth clamping unit 51 then takes over the support of the end region 900 of the terminal-attached electric wire 9 from the second clamping unit 31 at the third intermediate position P3.

The fourth clamping unit 51 includes a front fourth clamping unit 51a and a rear fourth clamping unit 51b. Each of the front fourth clamping unit 51a and the rear fourth clamping unit 51b has a pair of fourth opposing members 511, and a fourth separating and approximating actuator 512 for bringing the pair of fourth opposing members 511 close to each other and away from each other in the second direction (Y-axis direction).

The pair of fourth opposing members 511 of the front fourth clamping unit 51a clamp and support a part of the terminal 92 in the end region 900 of the terminal-attached electric wire 9. On the other hand, the pair of fourth opposing members 511 of the rear fourth clamping unit 51b clamp and support a part of the electric wire 91 in the end region 900 of the terminal-attached electric wire 9.

Since the fourth clamping unit 51 includes the front fourth clamping unit 51a and the rear fourth clamping unit 51b, it is possible to perform the operations of clamping and unclamping the terminal 92 of the terminal-attached electric wire 9, and the operations of clamping and unclamping the electric wire 91 of the terminal-attached electric wire 9, independently.

The fourth separating and approximating actuators 512 bring the pairs of fourth opposing members 511 close to each other or away from each other in the second direction. Accordingly, each fourth separating and approximating actuator 512 switches the state of the pair of second opposing members 311 to the state in which the end region 900 of the terminal-attached electric wire 9 is clamped, or to the state in which the clamping of the end region 900 is released. The fourth separating and approximating actuators 512 are, for example, solenoid actuators, ball screw-type electric actuators, or the like.

The front fourth clamping unit 51a and the rear fourth clamping unit 51b are insertion wire end holding units that can hold an end of a terminal-attached electric wire 9 when a terminal 92 is inserted into a cavity 81 of a connector 8.

The third direction transport mechanism 52 of the fourth clamping unit-associated mechanism 5 is a mechanism for moving the fourth clamping unit 51 in the third direction. The third direction transport mechanism 52 includes a front third direction transport mechanism 52a for moving the front fourth clamping unit 51a in the third direction, and a rear third direction transport mechanism 52b for moving the rear fourth clamping unit 51b in the third direction.

Since the third direction transport mechanism 52 of the fourth clamping unit-associated mechanism 5 includes the front third direction transport mechanism 52a and the rear third direction transport mechanism 52b, it is possible to perform the operation of moving the front fourth clamping unit 51a in the third direction, and the operation of moving the rear fourth clamping unit 51b in the third direction, independently.

In the fourth clamping unit-associated mechanism 5, the third direction transport mechanism 52 moves the fourth clamping unit 51 in the third direction (the positive Z-axis direction) by a difference in the distance in the third direction between the known third intermediate position P3 and the known position of the target cavity 81 located at the end position P4. Of course, if there is no difference in the distance, the third direction transport mechanism 52 does not move the fourth clamping unit 51.

This third direction transport mechanism 52 is also used as a relative position changing mechanism for changing the relative positional relationship between the fixing seat 61, which is a connector supporting unit, and the front fourth clamping unit 51a and the rear fourth clamping unit 51b, which are insertion wire end holding units, in a direction orthogonal to the axis of the cavity 81 (X-axis direction). Particularly, the third direction transport mechanism 52, which serves as the relative position changing mechanism, moves the front fourth clamping unit 51a and the rear fourth clamping unit 51b in the Z-direction, and thereby changes the relative positional relationship between the fixing seat 61, and the front fourth clamping unit 51a and the rear fourth clamping unit 51b in the Z-direction. Here, the front fourth clamping unit 51a and the rear fourth clamping unit 51b clamp the end of the terminal-attached electric wire 9 in the Y-direction. Therefore, the Z-direction is also a direction that is orthogonal to the axis direction (X-direction) of the cavity 81, and that is orthogonal to the direction (Y-direction) in which the front fourth clamping unit 51a and the rear fourth clamping unit 51b clamp the end of the terminal-attached electric wire 9.

Note that the relative position changing mechanism may be a configuration for moving a member supporting the connector 8 to a member holding the end of the terminal-attached electric wire 9.

Furthermore, the first direction transport mechanism 53 of the fourth clamping unit-associated mechanism 5 moves the fourth clamping unit 51 in the first direction (positive X-axis direction) by a distance that corresponds to a sum of a difference in the distance in the first direction between the known third intermediate position P3 and the known position of the entrance of the target cavity 81 located at the end position P4, and the depth of the target cavity 81.

This first direction transport mechanism 53 is an insertion advancing and retracting driving unit for advancing and retracting the front fourth clamping unit 51a and the rear fourth clamping unit 51b, which are the insertion wire end holding units, toward and away from the cavity 81.

By the above-described operations of the third direction transport mechanism 52 and the first direction transport mechanism 53, the terminal 92 of the terminal-attached electric wire 9 is moved from the third intermediate position P3, and is inserted into the target cavity 81 that is located at the end position P4.

In the present embodiment, the third direction transport mechanism 52 is provided with the slide supporting portion 321, which supports the second clamping unit 31 so that it can move in the first direction, and the linear actuator 322 for moving the slide supporting portion 321 in the first direction.

In the present embodiment, the third direction transport mechanism 52 moves the fourth clamping unit 51 in the third direction while directly supporting it, and the first direction transport mechanism 53 moves the third direction transport mechanism 52 in the first direction while supporting it.

For example, the first direction transport mechanism 53 is provided with a slide supporting portion 531, which supports the third direction transport mechanism 52 so that is can move in the first direction, and a linear actuator 532 for moving the third direction transport mechanism 52 in the third direction. The third direction transport mechanism 52 and the linear actuator 532 are, for example, well-known ball screw-type electric actuators, or the like.

Note that the third direction transport mechanism 52 and the first direction transport mechanism 53 of the fourth clamping unit-associated mechanism 5 serve as examples of a fourth clamping unit transport mechanism for inserting the terminals 92 of the terminal-attached electric wires 9 into the cavities 81 of the connectors 8 by moving the fourth clamping unit 51.

Furthermore, the second direction transport mechanism 33 of the second clamping unit-associated mechanism 3 serves as an example of a second clamping unit transport mechanism for moving the second clamping unit 31 in the second direction. The second direction transport mechanism 33 moves the second clamping unit 31 between the second intermediate position P2, at which it takes over the support of the terminal 92 from the third clamping unit 4, and the third intermediate position P3, at which it hands over the support of the terminal-attached electric wire 9 to the fourth clamping unit 51.

Note that as shown in FIG. 1, the terminal insertion device 100 is provided also with a wire hook portion 70. The wire hook portion 70 is driven by a not-shown driving mechanism so as to be displaced between the end position P4 and the third intermediate position P3, and hooks to the electric wire 91 of the terminal-attached electric wire 9 whose terminal 92 has already been inserted into the cavity 81 so as to distance the electric wire 91 away from the end position P4. Accordingly, the electric wire 91 protruding from the connector 8 is prevented from disturbing the insertion of the terminal 92 of a new terminal-attached electric wire 9.

### Control Unit

The control unit 10 is a device for controlling the actuators of the wire arraying member transport mechanism 1, the terminal insertion mechanisms 2 to 5, and the connector arraying member transport mechanism 6, with reference to a detection signal of the light sensor 7. Note that in FIG. 2, an illustration of the control unit 10 is omitted.

The control unit 10 is provided with a calculation unit 101, a storage unit 102, and a signal interface 103. The calculation unit 101, the storage unit 102, and the signal interface 103 are electrically connected to each other.

The calculation unit 101 is an element or a circuit that includes a CPU (Central Processing Unit) for executing processing of giving control instructions to the actuators according to control programs stored in advance in the storage unit 102.

The storage unit 102 is a nonvolatile memory that stores the control programs that are to be referenced by the calculation unit 101, and other pieces of data. For example, the storage unit 102 stores, in addition to the control programs, data such as predetermined path transport data, terminal-cavity correspondence data, electric wire position data, and cavity position data.

The predetermined path transport data includes data representing an operation procedure for moving the end region 900 of the terminal-attached electric wire 9 along a predetermined path from the start position P0 to the straight path R0, the operation procedure being performed by the actuator of the first clamping unit-associated mechanism 2. The predetermined path transport data furthermore includes data representing an operation procedure for moving the end region 900 along a predetermined path from the position at which the terminal 92 is detected by the light sensor 7 to the third intermediate position P3 via the first intermediate position P1 and the second intermediate position P2, the operation procedure being performed by the actuator of the second clamping unit-associated mechanism 3.

The terminal-cavity correspondence data is data representing the correspondence relationship between the identification codes of the respective wire retaining portions 902 of the wire arraying member 90 that clamp electric wires 91, and the identification codes of the respective cavities 81 into which the terminals 92 are inserted. The terminal-cavity correspondence data furthermore represents the order of the wire retaining portions 902 that are to be positioned at the start position P0.

The electric wire position data includes data necessary for specifying the respective positions of the wire retaining portions 902 on the wire arraying member 90. In other words, the electric wire position data includes data necessary for specifying the amount of operation of the linear actuator 12 of the wire arraying member transport mechanism 1 when it moves the respective wire retaining portions 902 to the start position P0.

Furthermore, the cavity position data includes data necessary for specifying the positions and depths, in the second direction (Y-axis direction) and the third direction (Z-axis direction), of the cavities 81 of the connectors 8 supported on the connector arraying member 80. In this case, the positions, in the first direction (X-axis direction), of the entrances of the cavities 81 are all the same known positions.

In other words, the data on the positions of the cavities 81 in the second direction that is included in the cavity position data is data necessary for specifying the amount of operation of the linear actuator 62 of the connector arraying member transport mechanism 6 when it moves the cavities 81 of the connectors 8 supported on the connector arraying member 80 to the end position P4.

Furthermore, the data on the positions and depths of the cavities 81 in the third direction that is included in the cavity position data is data necessary for specifying the amounts of operations of the third direction transport mechanism 52 and the first direction transport mechanism 53 of the fourth clamping unit-associated mechanism 5 when they move the terminal 92 of the terminal-attached electric wire 9 from the third intermediate position P3 into the target cavity 81.

The signal interface 103 inputs a detection signal from the light receiving unit 72 of the light sensor 7, and transmits the detection signal to the calculation unit 101. Furthermore, the signal interface 103 inputs control instructions that were given to the actuators by the calculation unit 101, converts the control instructions into driving signals for the actuators, and outputs the resulting driving signals.

### Wiring Module Manufacturing Process

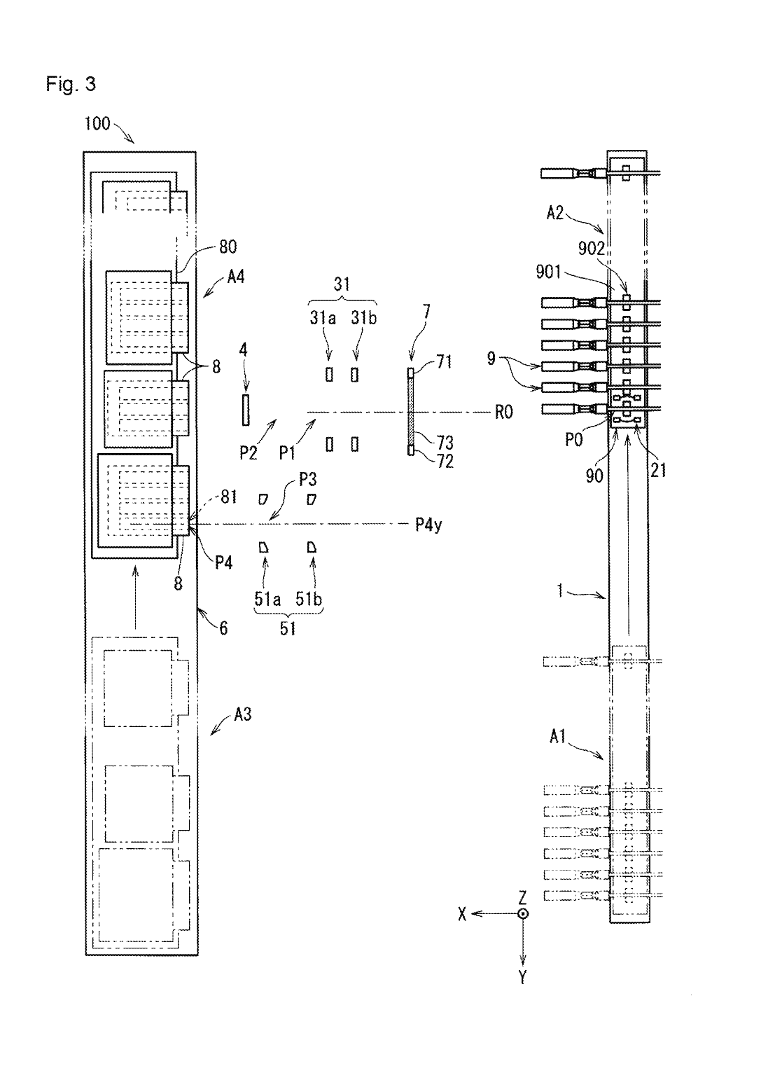

The following will describe an example of processing that is performed by the terminal insertion device 100 with reference to FIGS. 3 to 12. The terminal insertion device 100 executes, of the processes for producing the wiring module 200 including a plurality of terminal-attached electric wires 9 and a plurality of connectors 8 connected to ends thereof, a terminal inserting process for inserting the respective terminals 92 of the terminal-attached electric wires 9 into the cavities 81 of the connectors 8.

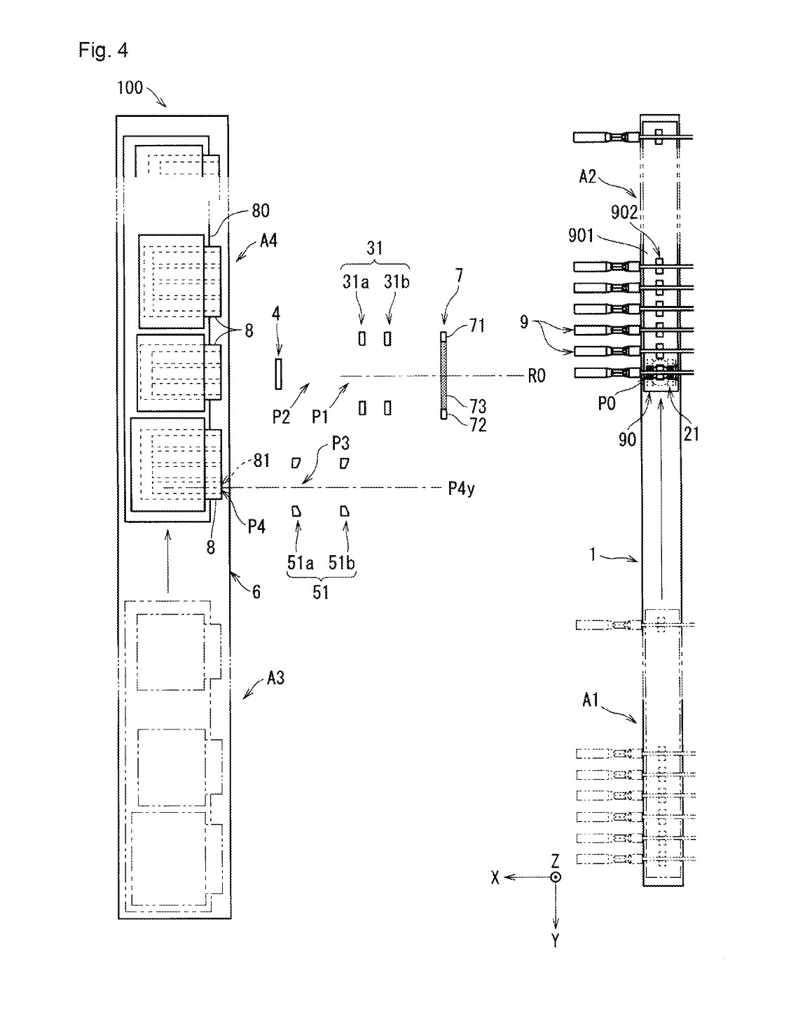

Note that for convenience, in FIGS. 3 to 12, only those portions of the terminal insertion mechanisms 2 to 5 that clamp parts of the end regions 900 of the terminal-attached electric wires 9 are schematically illustrated, and illustrations of other mechanisms are omitted. Furthermore, in FIGS. 4 to 12, illustrations of the wire arraying member transport mechanism 1 and the connector arraying member transport mechanism 6 are omitted.

Furthermore, for convenience, FIGS. 4 to 12 show the first clamping unit 21, the second clamping unit 31, the third clamping unit 4, and the fourth clamping unit 51 that clamp the end region 900 of the terminal-attached electric wire 9 in black, and that are in the state in which the clamping of the end region 900 of the terminal-attached electric wire 9 is released in white.

The terminal inserting process includes a start/end position deciding process, a clamping start process, a first transport primary process, a first transport secondary process, a first transfer process, a second transport process, a second transfer process, a third transport process, a third transfer process, a fourth transport primary process, and a fourth transport secondary process.

Note that the mechanisms that operate in the processes operate in accordance with the control instructions given by the calculation unit 101 executing the control programs stored in the storage unit 102 of the control unit 10. At this time, the calculation unit 101 of the control unit 10 outputs control signals to the mechanisms via the signal interface 103 with reference to various types of data stored in the storage unit 102 and results of detection by the light sensor 7, and thereby lets the mechanisms execute the above-described processes.

Also, prior to the execution of the above-described processes, the module of the wire arraying member 90 is fixed to the fixing seat 11 in a state in which the fixing seat 11 is positioned at the first waiting position A1 by the wire arraying member transport mechanism 1. Furthermore, the module of the connector arraying member 80 is fixed to the fixing seat 61 in a state in which the fixing seat 61 is positioned at the second waiting position A3 by the connector arraying member transport mechanism 6.

### Start/End Position Deciding Process

The start/end position deciding process includes a start position deciding process and an end position deciding process.

As shown in FIG. 3, the start position deciding process is a process in which the wire arraying member transport mechanism 1 selectively positions a wire retaining portion 902 of the wire arraying member 90 at the start position P0. In this process, the control unit 10 sequentially specifies the target wire retaining portion 902 to be moved to the start position P0 based on the terminal-cavity correspondence data in the storage unit 102.

Then, the wire arraying member transport mechanism 1 moves the wire arraying member 90 in the second direction, and thereby positions the target wire retaining portion 902 specified by the control unit 10 at the start position P0.

On the other hand, the end position deciding process is a process in which the connector arraying member transport mechanism 6 moves the connector arraying member 80 in the second direction, and thereby selectively positions a cavity 81 of a connector 8 at the end position P4 in the second direction. In this process, the control unit 10 sequentially specifies the target cavity 81 to be moved to the end position P4 based on the terminal-cavity correspondence data in the storage unit 102.

Then, the connector arraying member transport mechanism 6 moves the connector arraying member 80 in the second direction, and thereby positions the target cavity 81 specified by the control unit 10 at the end position P4. Note that if the last target cavity 81 and the current target cavity 81 are lined up in the third direction, the connector arraying member transport mechanism 6 will not move the connector arraying member 80 in this process.

The start position deciding process and the end position deciding process may be performed in parallel, for example. Alternatively, these processes may be performed sequentially.

The start/end position deciding process is executed each time the control unit 10 sequentially specifies a target wire retaining portion 902. Also, each time the start/end position deciding process is executed, the clamping start process, first transport primary process, first transport secondary process, first transfer process, second transport process, second transfer process, third transport process, third transfer process, fourth transport primary process, and fourth transport secondary process, which will be described later, are executed.

The process shown in FIG. 3 is a first start/end position deciding process, and this process serves also as an operation position shift process.

As shown in FIG. 3, the operation position shift process includes a first operation position shift process in which the wire arraying member transport mechanism 1 moves the wire arraying member 90 supporting the end regions 900 of the plurality of terminal-attached electric wires 9 from the first waiting position A1 to the first operation position A2.

Furthermore, the operation position shift process includes a second operation position shift process in which the connector arraying member transport mechanism 6 moves the connector arraying member 80 supporting the plurality of connectors 8 from the second waiting position A3 to the second operation position A4.

The first operation position shift process and the second operation position shift process may be performed in parallel, for example. Alternatively, these processes may be performed sequentially.

### Clamping Start Process

As shown in FIG. 4, the clamping start process is a process in which the first clamping unit 21 clamps a part of the end region 900 of the terminal-attached electric wire 9 at the predetermined start position P0 in a state in which the front end of the terminal 92 is directed in the first direction. In the present embodiment, the first clamping unit 21 clamps the electric wire 91 in the end region 900 of the terminal-attached electric wire 9 at two positions from both sides in the second direction.

The two positions of the electric wire 91 at which it is clamped by the first clamping unit 21 are two positions located on both sides of the portion clamped by the wire retaining portion 902. Accordingly, when the first clamping unit 21 clamping the electric wire 91 is moved in the third direction, the electric wire 91 is likely to be removed from the wire retaining portion 902 smoothly without being bent.

### First Transport Primary Process

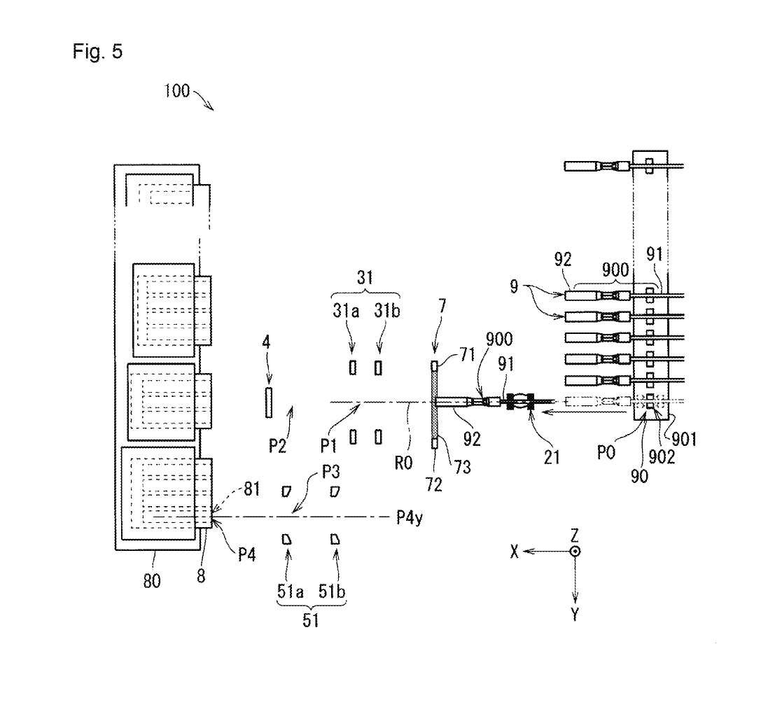

As shown in FIG. 5, the first transport primary process is a process in which the third direction transport mechanism 22 of the first clamping unit-associated mechanism 2 moves the first clamping unit 21 in the third direction by a predetermined distance, and then the first direction transport mechanism 23 of the first clamping unit-associated mechanism 2 moves the first clamping unit 21 along the straight path R0 in the first direction.

In this process, the first direction transport mechanism 23 moves the first clamping unit 21 along the given straight path R0 in the first direction, and if, during this movement, the light sensor 7 detects the front end portion of the terminal 92, the process executed by the first direction transport mechanism 23 and the third direction transport mechanism 22 moves to the first transport secondary process that follows.

For example, in this process, the first direction transport mechanism 23 of the first clamping unit-associated mechanism 2 moves the first clamping unit 21 along the given straight path R0 by a predetermined first distance with a first speed. Here, the first distance is set in a range in which the terminals 92 do not reach the detection light 73 regardless of the variation in the initial positions of the terminal-attached electric wires 9. Then, the first direction transport mechanism 23 moves the first clamping unit 21 along the given straight path R0 with a second speed that is lower than the first speed, until the light sensor 7 detects the front end portion of the terminal 92.

The above-described operation prevents an error in positioning of the terminal 92 from becoming too large to ignore due to a delay of feedback control for controlling the first direction transport mechanism 23 according to a result of detection by the light sensor 7. Furthermore, the above-described operation accelerates the speed of the transport of the terminal-attached electric wire 9 while suppressing the error in positioning of the terminal 92, resulting in a reduction in an execution time of the process.

Note that the process in which the light sensor 7 detects an object (the front end portion of the terminal 92) that blocks the detection light 73 is executed while at least the first transport primary process is executed.

### First Transport Secondary Process

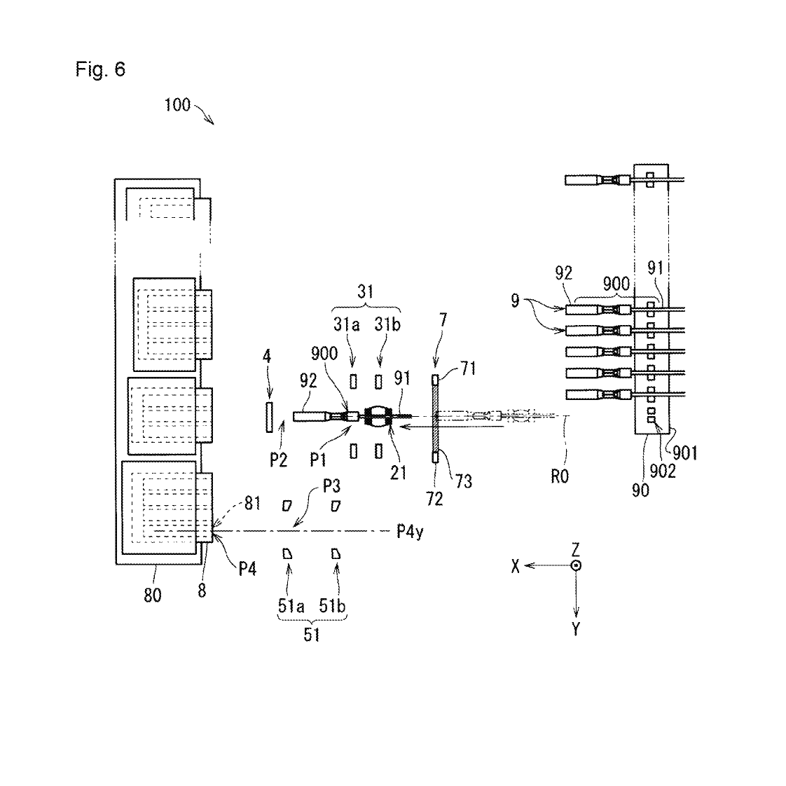

As shown in FIG. 6, the first transport secondary process is a process in which the first direction transport mechanism 23 of the first clamping unit-associated mechanism 2 moves the first clamping unit 21 along the straight path R0 in the first direction by a predetermined distance from the point in time at which the light sensor 7 detects the terminal 92, and then the third direction transport mechanism 22 of the first clamping unit-associated mechanism 2 moves the first clamping unit 21 in a direction opposite to the third direction (the negative Z-axis direction) by a predetermined distance. By this process, the end region 900 of the terminal-attached electric wire 9 is moved to the first intermediate position P1.

### First Transfer Process

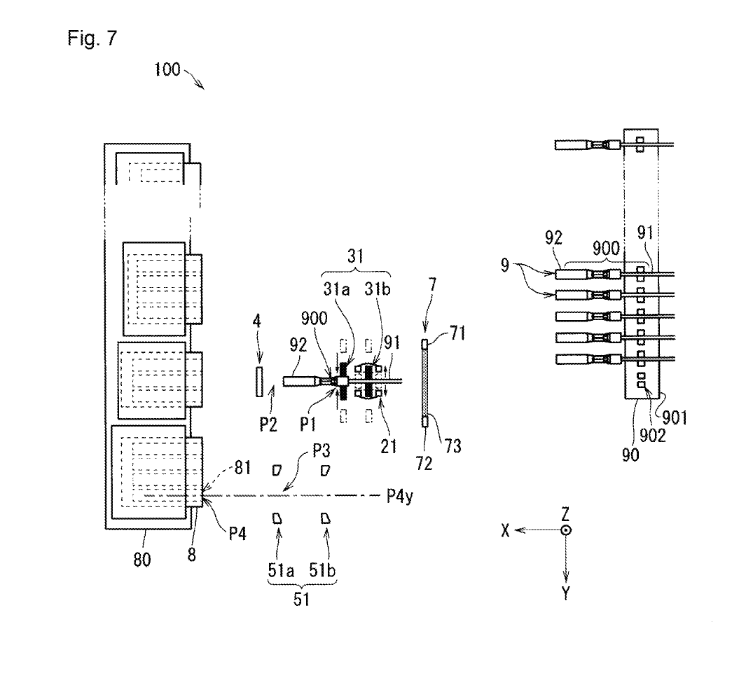

As shown in FIG. 7, the first transfer process is a process in which the second clamping unit 31 clamps, at the first intermediate position P1, a part of the terminal 92 and a part of the electric wire 91 in the end region 900 of the terminal-attached electric wire 9 clamped by the first clamping unit 21 from both sides in the second direction.

Furthermore, in this process, the first clamping unit 21 releases the clamping of the electric wire 91. Accordingly, the second clamping unit 31 takes over the support of the terminal-attached electric wire 9 from the first clamping unit 21.

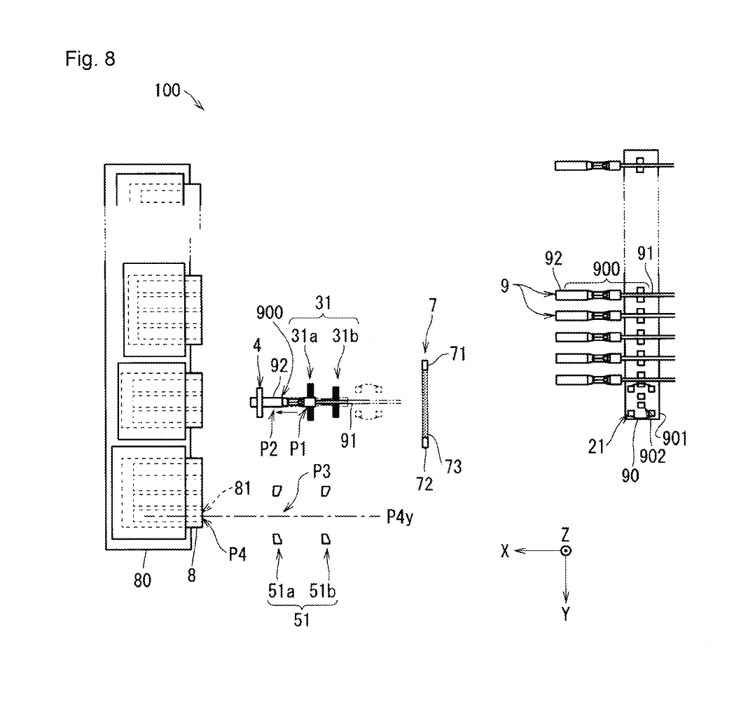

As shown in FIG. 8, the second transport process is a process in which the first direction transport mechanism 32 of the second clamping unit-associated mechanism 3 moves the second clamping unit 31 in the first direction by a predetermined distance. In this process, the first direction transport mechanism 32 moves the end region 900 of the terminal-attached electric wire 9 from the first intermediate position P1, which is apart from the third clamping unit 4, to the second intermediate position P2, at which the third clamping unit 4 performs clamping.

### Second Transfer Process

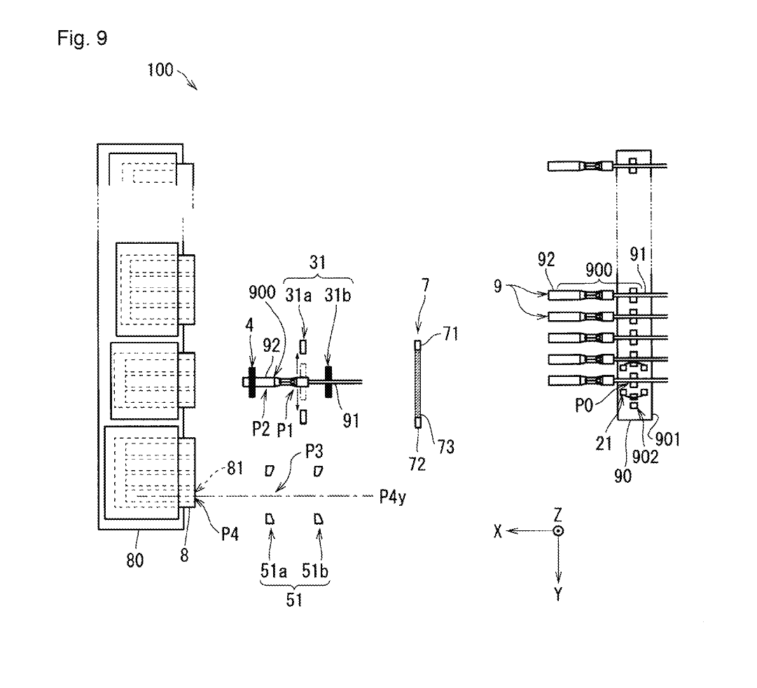

As shown in FIG. 9, the second transfer process is a process in which the third clamping unit 4 temporarily clamps, at the second intermediate position P2, a part of the terminal 92 in the end region 900 of the terminal-attached electric wire 9 clamped by the second clamping unit 31 from both sides in the third direction.

Furthermore, in this process, the front second clamping unit 31a temporarily releases the clamping of the terminal 92 when the third clamping unit 4 clamps the terminal 92, and again clamps the terminal 92. In other words, the third clamping unit 4 temporarily takes over the support of the terminal 92 of the terminal-attached electric wire 9 from the second clamping unit 31, and then hands over the support to the second clamping unit 31.

Note that in this process, it is also conceivable that, like the front second clamping unit 31a, the rear second clamping unit 31b temporary releases the clamping of the electric wire 91 when the third clamping unit 4 clamps the terminal 92, and then again clamps the electric wire 91.

### Third Transport Process

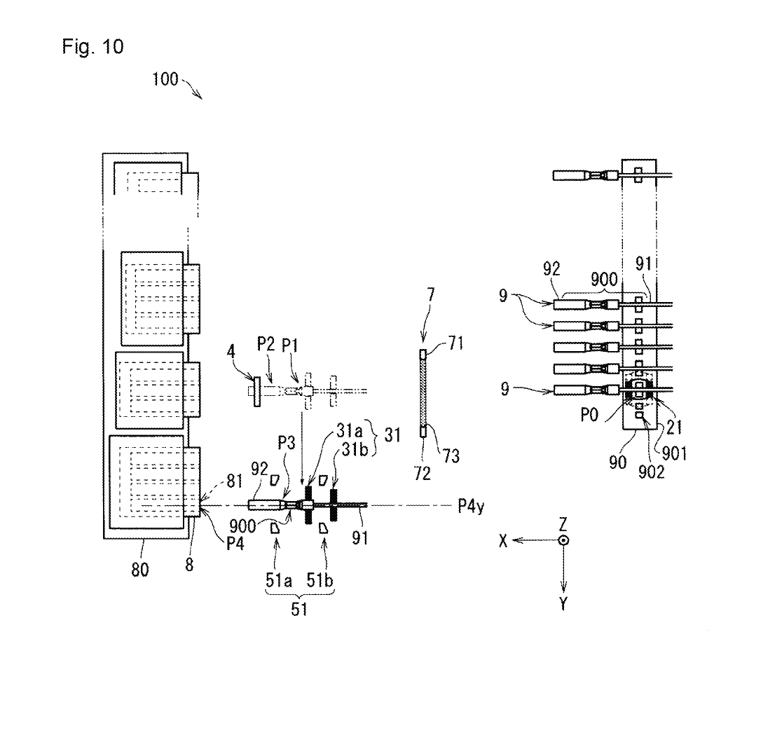

As shown in FIG. 10, the third transport process is a process in which the second direction transport mechanism 33 of the second clamping unit-associated mechanism 3 moves the second clamping unit 31 in the second direction by a predetermined distance. By this process, the second direction transport mechanism 33 moves the second clamping unit 31 from the given second intermediate position P2 to the given third intermediate position P3. As described above, the second intermediate position P2 is a position at which the second clamping unit 31 takes over the support of the terminal 92 from the third clamping unit 4, and the third intermediate position P3 is a position at which the second clamping unit 31 hands over the support of the terminal-attached electric wire 9 to the fourth clamping unit 51.

### Third Transfer Process

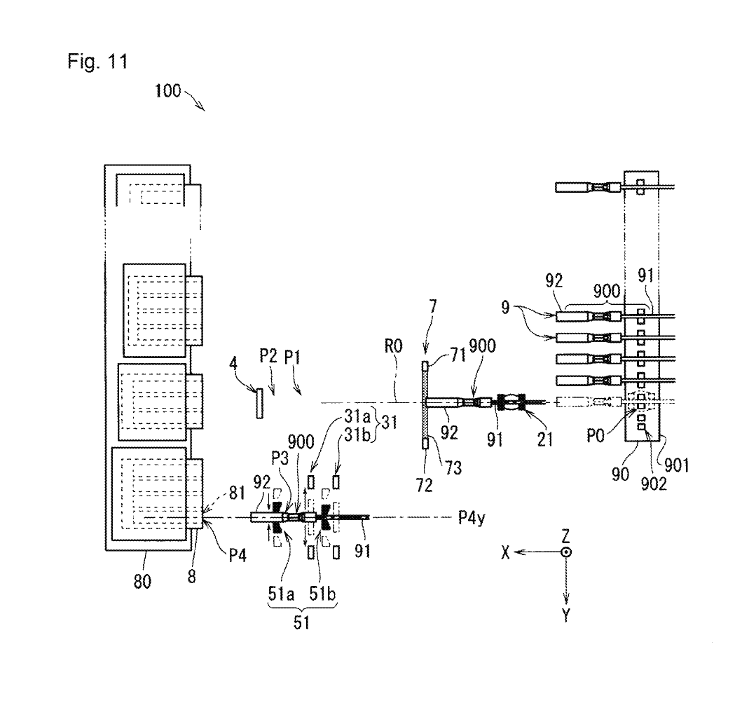

As shown in FIG. 11, the third transfer process is a process in which the fourth clamping unit 51 clamps, at the third intermediate position P3, a part of the terminal 92 and a part of the electric wire 91 in the end region 900 of the terminal-attached electric wire 9 that is clamped by the second clamping unit 31 after the second clamping unit 31 took over the support thereof from the third clamping unit 4.

Furthermore, in this process, the second clamping unit 31 releases the clamping of the end region 900 of the terminal-attached electric wire 9 when the fourth clamping unit 51 clamps the end region 900. Accordingly, the fourth clamping unit 51 takes over the support of the terminal-attached electric wire 9 from the second clamping unit 31.

### Fourth Transport Primary Process

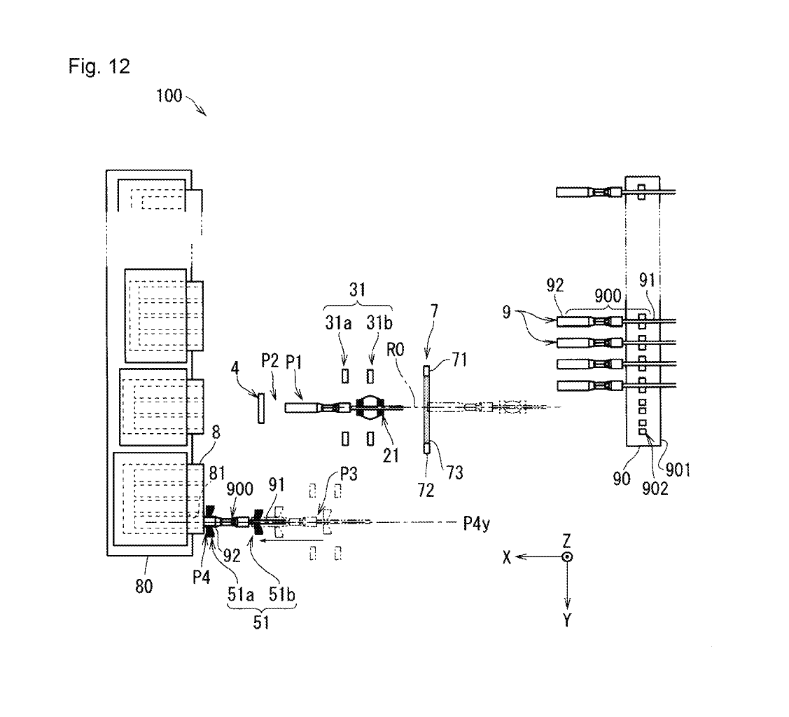

As shown in FIG. 12, the fourth transport primary process is a process in which the third direction transport mechanism 52 and the first direction transport mechanism 53 of the fourth clamping unit-associated mechanism 5 moves the front end portion of the terminal 92 of the terminal-attached electric wire 9 from the third intermediate position P3 into the cavity 81 at the end position P4 by moving the fourth clamping unit 51.

In this process, the third direction transport mechanism 52 moves the fourth clamping unit 51 in the third direction (the positive Z-axis direction) by a difference in the distance in the third direction between the known third intermediate position P3 and the known position of the target cavity 81. Of course, if there is no difference in the distance, the third direction transport mechanism 52 does not move the fourth clamping unit 51.

Furthermore, in this process, the first direction transport mechanism 53 of the fourth clamping unit-associated mechanism 5 moves the fourth clamping unit 51 in the first direction (positive X-axis direction) by a distance that corresponds to a difference in the distance in the first direction between the known third intermediate position P3 and the known position of the entrance of the target cavity 81 located at the end position P4. Accordingly, the front end portion of the terminal 92 is inserted into the target cavity 81.

As described above, in the fourth transport primary process, the third direction transport mechanism 52 and the first direction transport mechanism 53 of the fourth clamping unit-associated mechanism 5 moves the fourth clamping unit 51, according to the moving procedure that is defined based on the comparison between the third intermediate position P3, at which the fourth clamping unit 51 took over the support of the terminal-attached electric wire 9 from the second clamping unit 31, and the preset position of the corresponding cavity 81 of the connector 8.

### Fourth Transport Secondary Process

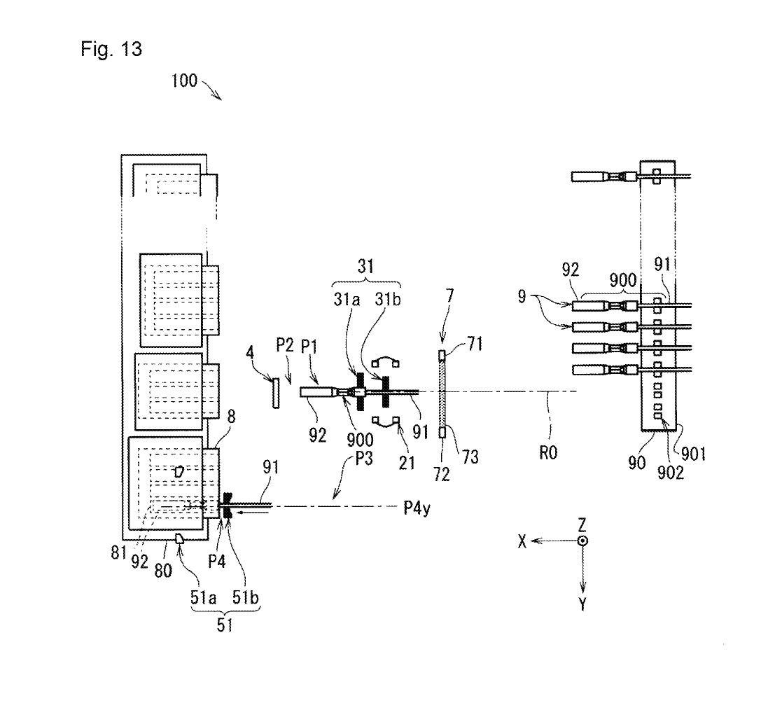

As shown in FIG. 13, the fourth transport secondary process is a process in which the first direction transport mechanism 53 of the fourth clamping unit-associated mechanism 5 further moves the rear fourth clamping unit 51b in the first direction by a distance that corresponds to the depth of the target cavity 81 while the rear fourth clamping unit 51b clamps the electric wire 91 of the end region 900.

In this process, the front fourth clamping unit 51a releases the clamping of the terminal 92, and the front third direction transport mechanism 52a of the fourth clamping unit-associated mechanism 5 moves the front fourth clamping unit 51a in the third direction to the position at which it does not interfere with the connector 8.

By the terminal insertion device 100 executing the foregoing processes, one terminal 92 of a terminal-attached electric wire 9 is inserted into a cavity 81 of a connector 8. Then, the terminal insertion device 100 repeatedly executes the foregoing processes until the insertion of terminals 92 into the cavities 81 of the plurality of connectors 8 supported on the connector arraying member 80 is completed.

When the insertion of the terminals 92 into the cavities 81 of the plurality of connectors 8 supported on the connector arraying member 80 is completed, the connector arraying member transport mechanism 6 moves the connector arraying member 80 from the second operation position A4 to the second waiting position A3. Then, the wire arraying member transport mechanism 1 moves the wire arraying member 90 from the first operation position A2 to the first waiting position A1.

Then, at the first waiting position A1 and the second waiting position A3, the wire arraying member 90 and the connector arraying member 80 are each replaced. The connector arraying member 80 that is removed at the second waiting position A3 from the connector arraying member transport mechanism 6 supports the plurality of connectors 8 all together in a state in which the terminals 92 of the terminal-attached electric wire 9 are inserted thereinto, the plurality of connectors 8 constituting one wire harness or one sub (partial) wire harness.

The connector arraying member 80 that is removed at the second waiting position A3 is delivered to the position of the next process while supporting the plurality of connectors 8 into which the terminals 92 of the terminal-attached electric wires 9 are inserted.

By repeating the foregoing processes, a wiring module 200 is produced that includes a plurality of terminal-attached electric wires 9 and a plurality of connectors 8, and in which the terminals 92 of the plurality of terminal-attached electric wires 9 are integrated with the cavities 81 of the connectors 8 while being inserted thereinto, as shown in FIG. 15.

### Details of Insertion Operation

In the present terminal insertion device 100, the light sensor 7 detects that the front end portion of the terminal 92 of the terminal-attached electric wire 9 moving along the given straight path R0 in the first direction has reached the position of the detection light 73. Then, the end region 900 of the terminal-attached electric wire 9 further moves in the first direction by a predetermined distance from the position at which the light sensor 7 has detected the terminals 92, and reaches the first intermediate position P1. Accordingly, first direction components of the variation in the position of the terminal 92 at the start position P0 are cancelled out at the point in time at which the end region 900 has reached the first intermediate position P1.

Furthermore, the second clamping unit 31 that is to take over the support of the terminal attached electric wire 9 clamps a part of the terminal 92 and a part of the electric wire 91 in the end region 900 of the terminal-attached electric wire 9 from both sides in the second direction. Accordingly, second direction components of the variation in the position of the terminal 92 at the start position P0 are cancelled out at the point in time at which the second clamping unit 31 has taken over the support of the terminal-attached electric wire 9.

Furthermore, the third clamping unit 4 that is to temporarily take over the support of the terminal 92 of the terminal-attached electric wire 9 clamps a part of the terminal 92 of the terminal-attached electric wire 9 from both sides in the third direction. Accordingly, third direction components of the variation in the position of the terminal 92 at the start position P0 are cancelled out at the point in time at which the third clamping unit has taken over the support of the terminal.

After the variations in the position of the terminal 92 have been cancelled out in the above-described manner, the rear fourth clamping unit 51 takes over the support of the end region 900 of the terminal-attached electric wire 9 from the second clamping unit 31, and moves according to the moving procedure that is defined based on the comparison between the third intermediate position P3, at which the fourth clamping unit 51 took over the support, and the position of the preset cavity 81 of the connector 8.

Of course, even with the above-described manner, it is difficult to completely prevent the terminal 92 from being supported by the fourth clamping unit 51 in a state in which it deviates from the position in which it is supposed to be supported. For example, the terminal 92 may be supported by the fourth clamping unit 51 in a state in which it is shifted upward or downward with respect to the position in which it is supposed to be supported. Or, the terminal 92 may be supported by the fourth clamping unit 51 in a state in which it is inclined with respect to the X-axis, and thereby the front end portion of the terminal 92 is supported in a state in which it is shifted upward or downward with respect to the position in which it is supposed to be supported.

In these cases, if the fourth clamping unit 51 is moved toward the cavities 81 of the connector 8 (see arrows Q2 and Q3), it is conceivable that the front end portion of the terminal 92 will abut against the circumferential edge of the opening of a cavity 81 of the connector 8, and the front end portion of the terminal 92 cannot be inserted into the cavity 81.

Hereinafter, a description will be given with focus on the operation in which the present terminal insertion device 100 inserts a terminal 92 into a cavity 81, and in particular, on the operation that is performed when the front end portion of the terminal 92 has abutted on the circumferential edge of the opening of the cavity 81 of the connector 8.

### Block Diagram

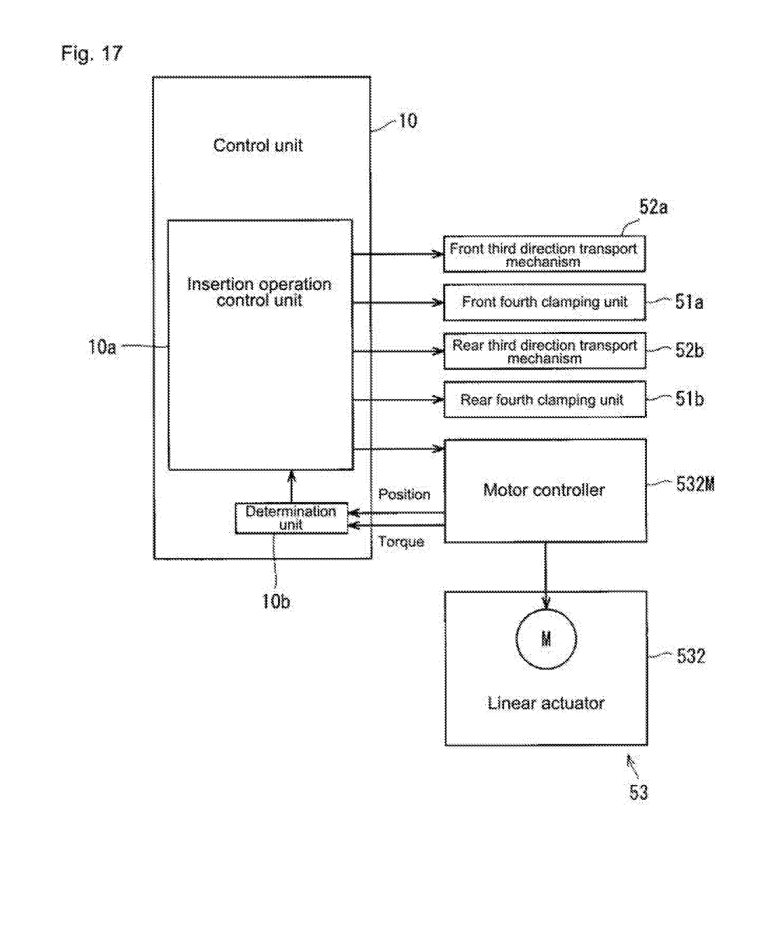

FIG. 17 is a functional block diagram illustrating a part of the present terminal insertion device 100 that is associated with the operation of inserting a terminal 92 into a cavity 81.

In this terminal insertion device 100, the front third direction transport mechanism 52a, the front fourth clamping unit 51a, the rear third direction transport mechanism 52b, and the rear fourth clamping unit 51b are connected to the control unit 10 so as to be able to be controlled by the control unit 10.

Furthermore, the first direction transport mechanism 53 is provided with the linear actuator 532, and a motor controller 532M for driving control of a motor M included in the linear actuator 532. The rotational movement of the motor M is converted into a force for advancing or retracting the front fourth clamping unit 51a and the rear fourth clamping unit 51b linearly toward or away from the cavity 81 with a ball-screw structure or the like. That is, the motor M generates a thrust force for advancing or retracting the front fourth clamping unit 51a and the rear fourth clamping unit 51b toward or away from the cavity 81.

The control unit 10 is connected so as to be able to control the motor M via the motor controller 532M. The motor M is constituted by a stepping motor or the like, and is controlled under the control of the motor controller 532M. That is, the configuration is such that if the control unit 10 gives instructions relating to the advancing or retracting movement direction or position of the first direction transport mechanism 53, or the like to the motor controller 532M, the motor controller 532M drives the motor M with respect to the rotational direction of the motor M (i.e., advancing or retracting movement direction), the amount of rotation (i.e., positions to which the front fourth clamping unit 51a and the rear fourth clamping unit 51b are to be advanced or retracted), or the like, in accordance with the instructions via the driving circuit.

Furthermore, the motor controller 532M is configured to be capable of detecting the amount of rotation of the motor M (i.e., positions to which the front fourth clamping unit 51a and the rear fourth clamping unit 51b are advanced or retracted) via an encoder or the like that is incorporated in the motor M, and detecting the torque of the motor M based on the driving current of the motor M, and the like. Signals indicating the amount of rotation of the motor M (i.e., position to which it is advanced or retracted) and the torque of the motor M that are detected by the motor controller 532M are input to the control unit 10.

Furthermore, the control unit 10 functions as an insertion operation control unit 10a and a determination unit 10b. The determination unit 10b determines whether or not the front end portion of a terminal 92 has entered a cavity 81 of a connector 8, based on the torque and the positions to which the front fourth clamping unit 51a and the rear fourth clamping unit 51b are advanced or retracted, the torque and the positions being given by the motor controller 532M. Based on a result of the determination and the like, the insertion operation control unit 10a controls the operations of the front third direction transport mechanism 52a, the front fourth clamping unit 51a, the rear third direction transport mechanism 52b, the rear fourth clamping unit 51b, and the first direction transport mechanism 53 so that the terminal 92 is inserted into the cavity 81. These operations will be described in detail with reference to the flowchart.

### Flowchart

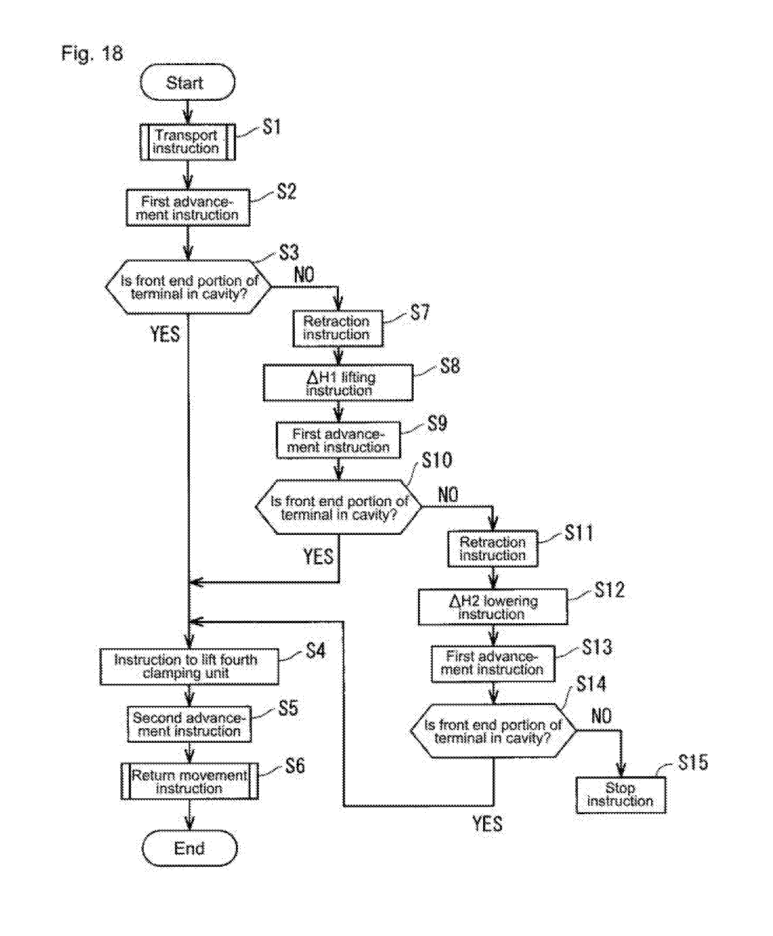

FIG. 18 is a flowchart illustrating processing of the present terminal insertion device 100 that is associated with the operations in which a terminal 92 is inserted into a cavity 81.

First, in step S1, the start/end position deciding process, the clamping start process, the first transport primary process, the first transport secondary process, the second transfer process, the third transport process, and the third transfer process are executed as described above. After the completion of step S1, an end of a terminal-attached electric wire 9 is clamped by the fourth clamping unit 51.

Then, in step S2, the insertion operation control unit 10a of the control unit 10 gives, to the first direction transport mechanism 53, a first advancement instruction to instruct the first direction transport mechanism 53 to advance the fourth clamping unit 51 toward the cavity 81 in order to insert the front end portion of the terminal 92 of the terminal-attached electric wire 9 held by the front end portion of the fourth clamping unit 51 into the cavity 81. The moving distance at this time is a distance that corresponds to a difference in the distance in the first direction between the third intermediate position P3 and the position of the entrance of the target cavity 81 located at the end position P4.

Then, in step S3, the determination unit 10b determines whether or not the front end portion of the terminal 92 has entered the cavity 81 based on the torque detection signal from the motor controller 532. Here, the detected torque of the motor M is one of the physical amounts that is required when the first direction transport mechanism 53 advances the fourth clamping unit 51.

At that time, if the front end portion of the terminal 92 is smoothly inserted into the cavity 81 without abutting on the circumferential edge of the opening of the cavity 81 of the connector 8, the torque will not increase so much. On the other hand, if the front end portion of the terminal 92 abuts against the circumferential edge of the opening of the cavity 81 of the connector 8, the torque of the motor M will increase due to the reaction force caused by this. Accordingly, it is possible to determine whether or not the front end portion of the terminal 92 has entered the cavity 81 based on the torque, for example, by comparing the torque with a predetermined threshold. Specifically, if the state in which the torque is lower than the predetermined threshold continues, it can be determined that the front end portion of the terminal 92 has entered the cavity 81, and if the torque exceeds the predetermined threshold, it can be determined that the front end portion of the terminal 92 has not entered the cavity 81. If the torque is equal to the predetermined threshold, either determination is possible.

The result of the determination by the determination unit 10b is given to the insertion operation control unit 10a, and if it is determined that the front end portion of the terminal 92 has entered the cavity 81, the procedure moves to step S4, whereas if it is determined that the front end portion of the terminal 92 has not entered the cavity 81, the procedure moves to step S7.

In step S4, the insertion operation control unit 10a gives an instruction to lift the fourth clamping unit to the fourth separating and approximating actuator 512 of the front fourth clamping unit 51a, and the front third direction transport mechanism 52a. Accordingly, the front fourth clamping unit 51a releases the clamping of the terminal 92, and the front third direction transport mechanism 52a lifts the front fourth clamping unit 51a in the third direction to a position at which it does not interfere with the connectors 8.

Then, in step S5, the insertion operation control unit 10a gives, to the first direction transport mechanism 53, a second advancement instruction to instruct the first direction transport mechanism 53 to advance the fourth clamping unit 51b toward the cavity 81 in order to insert the terminal 92 of the terminal-attached electric wire 9 held by the fourth clamping unit 51b to the rear of the cavity 81. The moving distance at this time is a distance from the position at which the front end portion of the terminal 92 has entered the cavity 81 to the rear of the cavity 81. Accordingly, the terminal 92 is inserted to the rear of the cavity 81.

Then, in step S6, the insertion operation control unit 10a gives return movement instructions to the components, and the front third direction transport mechanism 52a, the front fourth clamping unit 51a, the rear third direction transport mechanism 52b, the rear fourth clamping unit 51b, and the first direction transport mechanism 53 move to return to their original positions suitable for the next processing for the terminal-attached electric wire 9.

If, in step S3, it is determined that the front end portion of the terminal 92 has not entered the cavity 81, the procedure moves to step S7. In step S7, the insertion operation control unit 10a gives, to the first direction transport mechanism 53, a retraction instruction to instruct the first direction transport mechanism 53 to retract the fourth clamping unit 51 in a direction in which it moves away from the cavity 81. The amount of retraction at this time is a distance with which the front end portion of the terminal 92 of the terminal-attached electric wire 9 held by the fourth clamping unit 51 can be arranged at a position apart from the opening of the cavity 81 to the rear. The position after the retraction is preferably the third intermediate position P3, for example.

The subsequent step S9, the insertion operation control unit 10a gives, to the third direction transport mechanism 52, a movement instruction to move to lift the fourth clamping unit 51 by ΔH1. Accordingly, the front end portion of the terminal 92 of the terminal-attached electric wire 9 held by the fourth clamping unit 51 is lifted by ΔH1, and the relative positional relationship between the position of the cavity 81 of the connector 8, and the fourth clamping unit 51 is changed in a direction (here, the positive Z-axis direction) orthogonal to the axis of the cavity 81.

Next steps S9 and S10 are processes similar to the above steps S2 and S3. Accordingly, the fourth clamping unit 51 is again advanced toward the cavity 81. In step S10, it is again determined whether or not the front end portion of the terminal 92 has entered the cavity 81. If, in step S10, it is determined that the front end portion of the terminal 92 has entered the cavity 81, the processing after step S4 onward is executed, whereas if it is determined that the front end portion of the terminal 92 has not entered the cavity 81, the procedure moves to step S11.

In step S11, similar to above step S7, the insertion operation control unit 10a gives, to the first direction transport mechanism 53, a retraction instruction to instruct the first direction transport mechanism 53 to retract the fourth clamping unit 51 in a direction in which it moves away from the cavity 81.

Then, in step S12, the insertion operation control unit 10a gives, to the third direction transport mechanism 52, a movement instruction to move to lower the fourth clamping unit 51 by ΔH2. Accordingly, the front end portion of the terminal 92 of the terminal-attached electric wire 9 held by the fourth clamping unit 51 is lowered by ΔH2, and the relative positional relationship between the position of the cavity 81 of the connector 8, and the fourth clamping unit 51 is changed in a direction (here, the negative Z-axis direction) that is orthogonal to the axis of the cavity 81. Note that the absolute value of ΔH2 is larger than that of ΔH1. Preferably, ΔH2 is twice as much as ΔH1. This makes it possible to try the insertion again in a state in which the end of the terminal-attached electric wire 9 is moved upward and downward to the same extent with respect to a standard position, which is an ideal position at which it is held by the fourth clamping unit 51.

Next steps S13 and S14 are processes similar to the above steps S2 and S3. Accordingly, the fourth clamping unit 51 is again advanced toward the cavity 81. In step S14, it is again determined whether or not the front end portion of the terminal 92 has entered the cavity 81. If, in step S14, it is determined that the front end portion of the terminal 92 has entered into the cavity 81, the processing after step S4 onward is executed, whereas if it is determined that the front end portion of the terminal 92 has not entered the cavity 81, the procedure moves to step S15.

In step S15, the insertion operation control unit 10a gives stop instructions to the components. Accordingly, the operation of the present terminal insertion device 100 is stopped. At that time, it is preferable that a notification signal of performing notification of an insertion failure be output. A notification unit may perform notification using a sound such as a buzzer, or may perform visual notification using a display unit, such as a liquid crystal display unit, or a light emitting display unit.

### Regarding the Insertion Operation

The insertion operation according to the above-described processing will be described.

First, the operation that is performed when an end of a terminal-attached electric wire 9 is held at a predetermined position and orientation by the fourth clamping unit 51 will be described.

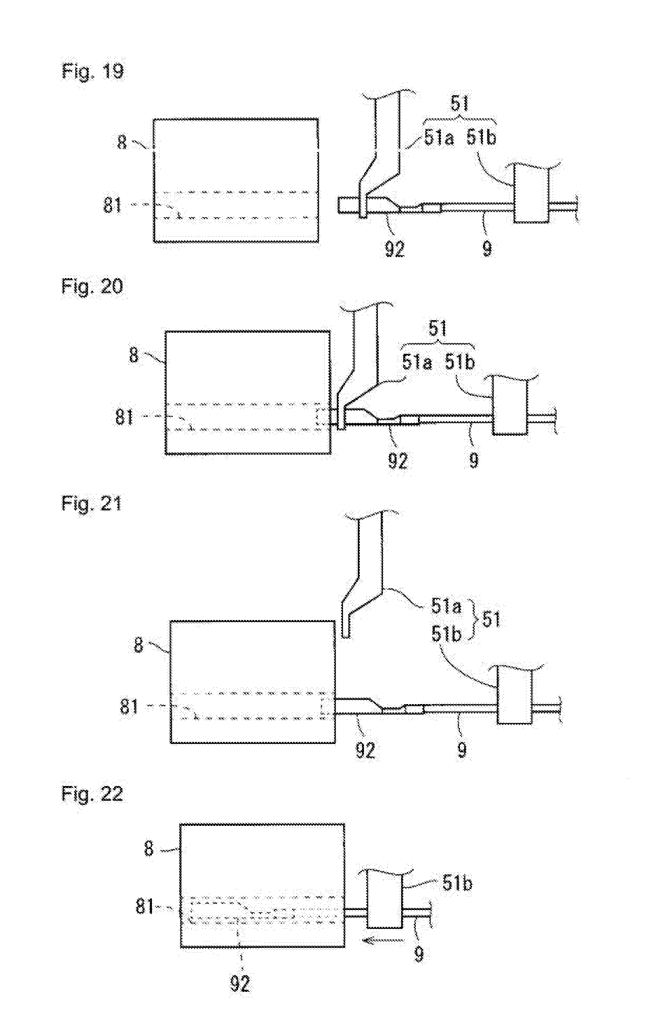

As shown in FIG. 19, the fourth clamping unit 51 holds the end of the terminal-attached electric wire 9. If, in this state, the first advancing processing (see step S2) is executed, the front end portion of the terminal 92 will be inserted into the opening portion of the cavity 81 as shown in FIG. 20.

When the processing for lifting the rear fourth clamping unit (see step S4) is executed, the front fourth clamping unit 51a is lifted as shown in FIG. 21. Then, when the second advancing processing (see step S5) is executed, the terminal 92 is inserted to the rear of the cavity 81 as shown in FIG. 22.

Next, the operation that is performed when the end of the terminal-attached electric wire 9 is held by the fourth clamping unit 51 at a position below the predetermined position will be described. Note that the same operation is performed also when the terminal 92 is inclined at the fourth clamping unit 51, and the front end portion of the terminal 92 is located below the predetermined position.

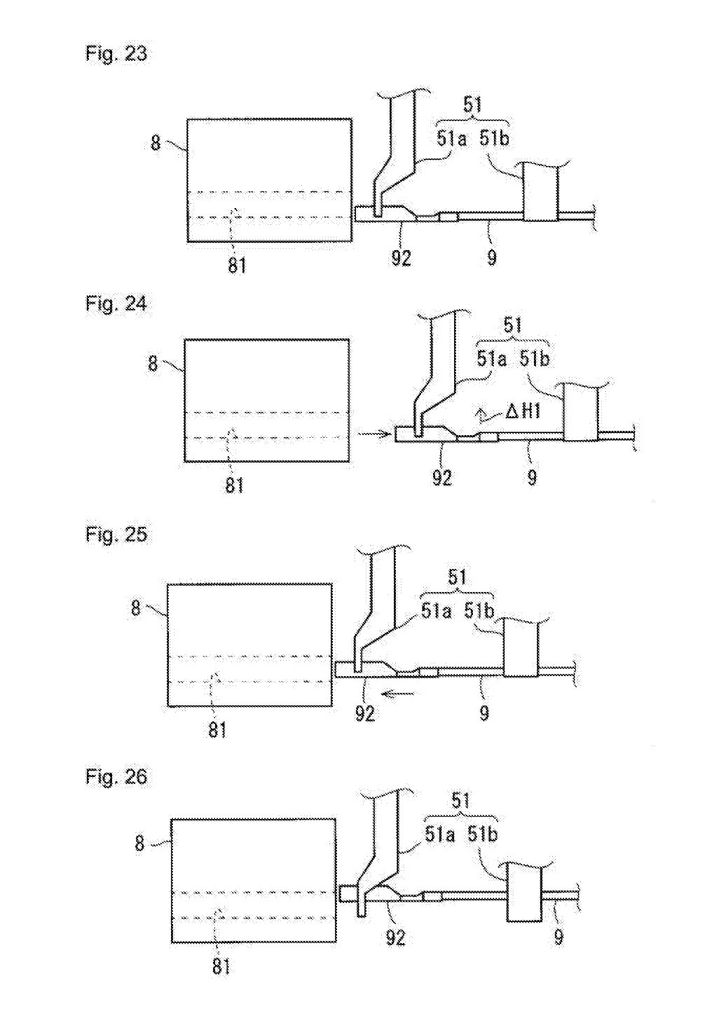

In this case, if the first advancing processing (see step S2) is executed, the front end portion of the terminal 92 will abut against the lower portion of the opening of the cavity 81 of the connector 8, as shown in FIG. 23. Accordingly, it is determined that the front end portion of the terminal 92 has not entered the cavity 81 (see step S3). Thus, as shown in FIG. 24, the retracting processing (see step S7) and the ΔH1 lifting processing (see step S8) will be executed.

Then, as shown in FIG. 25, the first advancing processing (see step S9) is again executed. By the processing, the front end portion of the terminal 92 can enter the opening of the cavity 81, and then the processing of inserting the terminal 92 into the cavity 81 can be executed.

The following will describe the operation that is performed when the end of the terminal-attached electric wire 9 is held by the fourth clamping unit 51 at a position above the predetermined position. Note that the same processing is performed also when the terminal 92 is inclined at the fourth clamping unit 51, and the front end portion of the terminal 92 is located above the predetermined position.

In this case, if the first advancing processing (see step S2) is executed, the front end portion of the terminal 92 will abut against the upper portion of the opening of the cavity 81 of the connector 8, as shown in FIG. 26. Accordingly, it is determined that the front end portion of the terminal 92 has not entered the cavity 81 (see step S3).

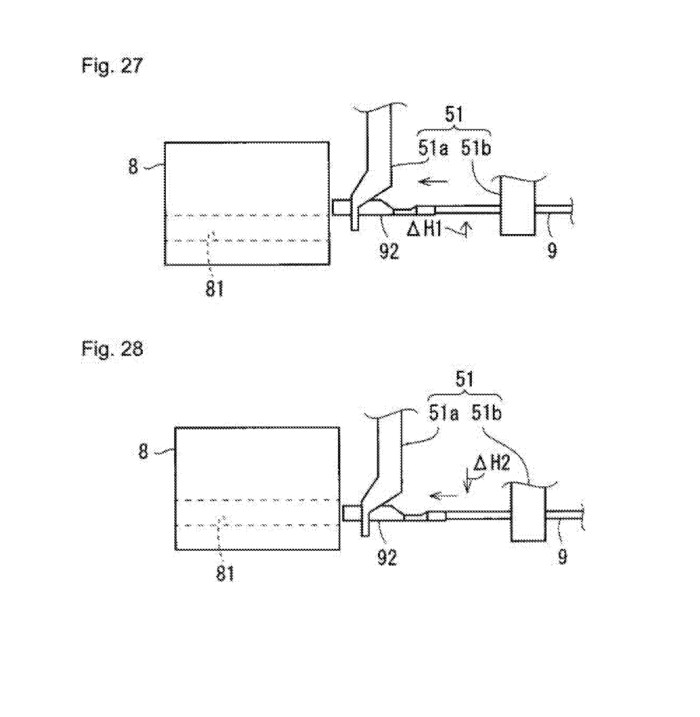

Therefore, as shown in FIG. 27, the retracting processing (see step S7) and the ΔH1 lifting processing (see step S8) will be executed, and then the first advancing processing (see step S9) will again be executed. However, since the terminal 92 is held at a position above the ideal position with respect to the fourth clamping unit 51, the front end portion of the terminal 92 will again abut against the upper portion of the opening of the cavity 81 of the connector 8 in the condition that it is lifted by ΔH1. Accordingly, it is determined that the front end portion of the terminal 92 has not entered the cavity 81 (see step S10).

Then, as shown in FIG. 28, the retracting processing (see step S11) and the ΔH2 lowering processing (see step S12) are executed, and the first advancing processing (see step S13) is again executed. Accordingly, the terminal 92 will move toward the cavity 81 while being lowered as compared to the case of the first insertion, the front end portion of the terminal 92 will enter the opening of the cavity 81, and then processing of inserting the terminal 92 into the cavity 81 will be able to be executed.

Note that if the end of the terminal-attached electric wire 9 at the fourth clamping unit 51 is displaced by more than ΔH1, or by an amount that is greater than that obtained by subtracting ΔH1 from ΔH2, the front end portion of the terminal 92 will repeatedly abut against the circumferential edge of the opening of the cavity 81 of the connector 8 even by executing the above processing. In this case, the processing of the device 100 is stopped (see step S15), and an appropriate correction or the like by an operator or the like will be performed.

According to the thus configured terminal insertion device 100 and method of manufacturing the wiring module 200, if it is determined that the front end portion of the terminal 92 has not entered, the fourth clamping unit 51 is retracted away from the cavity 81 and then the fourth clamping unit 51 is again advanced toward the cavity 81, thus enabling the front end portion of the terminal 92 to enter the cavity 81 more reliably. Also, by further inserting the terminal 92 after the front end portion of the terminal 92 has entered the cavity 81, it is possible to insert the terminal 92 into the cavity 81 more reliably. This makes it possible to efficiently perform the operation of sequentially inserting the terminals 92 of the terminal-attached electric wires 9 into the cavities 81 of the connectors 8.

Furthermore, if it is determined that the front end portion of the terminal 92 of the terminal-attached electric wire 9 has not entered the cavity 81, the relative positional relationship between the fourth clamping unit 51 and the cavity 81 is changed in a direction orthogonal to the axis of the cavity 81, and then the rear fourth clamping unit 51 is advanced toward the cavity 81, thus enabling the front end portion of the terminal 92 to enter the cavity 81 more reliably.

Particularly, since the fourth clamping unit 51 is configured to clamp and hold an end of a terminal-attached electric wire 9, it seems that the misalignment of the terminal 92 with respect to the cavity 81 is likely to occur in a direction (Z-axis direction) that is orthogonal to the direction in which it clamps the end. Accordingly, if it is determined that the front end portion of the terminal 92 of the terminal-attached electric wire 9 has not entered the cavity 81, the relative positional relationship between the fourth clamping unit 51 and the cavity 81 is changed in the Z-axis direction, and then the rear fourth clamping unit 51 is advanced toward the cavity 81. Thus, the possibility of overcoming the above-described misalignment is increased, enabling the front end portion of the terminal 92 to enter the cavity 81 more reliably.

Of course, it is not essential to change the relative positional relationship between the fourth clamping unit 51 and the cavity 81 in a direction orthogonal to the axis of the cavity 81, if it is determined that the front end portion of the terminal 92 of the terminal-attached electric wire 9 has not entered the cavity 81. It is also conceivable that the terminal 92 can be more likely to be inserted into the cavity 81 by repeatedly performing the reinsertion. Furthermore, if it is determined that the front end portion of the terminal 92 of the terminal-attached electric wire 9 has not entered the cavity 81, it is also possible to change the relative positional relationship between the fourth clamping unit 51 and the cavity 81 in a direction (i.e., the Y-axis direction) that is orthogonal to the axis of the cavity 81 and that is along the clamping direction.

Furthermore, since the determination whether or not the front end portion of the terminal 92 has entered the cavity 81 is made based on the torque detection signal of the motor M of the first direction transport mechanism 53, it is possible to perform the above-described determination with a simple configuration, without providing a separate sensor or the like for detecting a force exerted on the fourth clamping unit 51. Of course, it is also possible, for example, to provide a separate pressure sensor on a mechanism for supporting the fourth clamping unit to detect a force that is exerted on the fourth clamping unit.

Although the present invention has been described in detail so far, the description above is exemplary in all aspects, and the present invention is not limited to this. A variety of modifications that are not exemplified can be construed as not departing from the scope of the present invention.

### LIST OF REFERENCE NUMERALS

10 Control unit
100 Terminal insertion device
5 Fourth clamping unit-associated mechanism
51 Fourth clamping unit
511 Fourth opposing members
512 Fourth separating and approximating actuator
51a Front fourth clamping unit
51b Rear fourth clamping unit
52 Third direction transport mechanism (fourth clamping unit transport mechanism)
52a Front third direction transport mechanism
52b Rear third direction transport mechanism
53 First direction transport mechanism (fourth clamping unit transport mechanism)
531 Slide supporting portion
532 Linear actuator
6 Connector arraying member transport mechanism
61 Fixing seat
611 Connector arraying member locking mechanism
8 Connector
80 Connector arraying member
81 Cavity
9 Terminal-attached electric wire
91 Electric wire

1. A terminal insertion device for inserting a terminal at an end of a terminal-attached electric wire into a cavity of a connector, comprising:
a connector support that holds the connector;
an insertion wire end holder capable of holding the end of the terminal-attached electric wire;
an insertion advancing and retracting driver that advances and retracts the insertion wire end holder toward and away from the cavity; and
a controller that executes a step (a) of causing the insertion advancing and retracting driver to advance the insertion wire end holder toward the cavity in order to insert a front end portion of the terminal at the end of the terminal-attached electric wire held by the insertion wire end holder into the cavity of the connector, a step (b) of determining whether or not the front end portion of the terminal has entered the cavity based on a detection signal that corresponds to a physical amount that is required when the insertion advancing and retracting driver advances the insertion wire end holder in the step (a), and a step (c) of, if it is determined in the step (b) that the front end portion of the terminal has not entered the cavity, retracting the insertion wire end holder away from the cavity and then again advancing the insertion wire end holder toward the cavity,
the terminal insertion device further comprising:
a relative position changer that changes a relative positional relationship between the connector support and the insertion wire end holder in a direction orthogonal to the axis of the cavity,
wherein in the step (c), the controller lets the relative position changer change a relative positional relationship between the connector support and the insertion wire end holder in a direction orthogonal to the axis of the cavity, and then advances the insertion wire end holder toward the cavity.

2. (canceled)

3. The terminal insertion device according to claim 1,
wherein the insertion wire end holder is configured to be capable of clamping the end of the terminal-attached electric wire, and
in the step (c), the controller lets the relative position changer change the relative positional relationship between the connector support and the insertion wire end holder in a direction that is orthogonal to the axis of the cavity, and to the direction in which the insertion wire end holder clamps the end of the terminal-attached electric wire.

4. The terminal insertion device according to claim 1,
wherein the insertion advancing and retracting driver includes a motor for generating a thrust force for advancing and retracting the insertion wire end holder toward and away from the cavity, and
the controller determines whether or not the front end portion of the terminal has entered the cavity based on a torque of the motor.

5. A wiring module production method in which a terminal at an end of a terminal-attached electric wire is inserted into a cavity of a connector, and in which a terminal insertion device is used to produce a wiring module in which the terminal at the end of the terminal-attached electric wire is inserted into the cavity of the connector, the terminal insertion device including: a connector support that holds the connector; an insertion wire end holder capable of holding the end of the terminal-attached electric wire; and an insertion advancing and retracting driver that advances and retracts the insertion wire end holder toward and away from the cavity,
the wiring module production method comprising:
advancing the insertion wire end holder toward the cavity in order to insert a front end portion of the terminal at the end of the terminal-attached electric wire held by the insertion wire end holder into the cavity of the connector,
determining whether or not the front end portion of the terminal has entered the cavity based on a detection signal that corresponds to a physical amount required when the insertion advancing and retracting driver advances the insertion wire end holder in the step (a), and
if it is determined that the front end portion of the terminal has not entered the cavity, retracting the insertion wire end holder away from the cavity and then again advancing the insertion wire end holder toward the cavity,
wherein a relative positional relationship between the connector support and the insertion wire end holder is changed in a direction orthogonal to the axis of the cavity, and then the insertion wire end holder is advanced toward the cavity.
